(19) United States
(12) Patent Application Publication
(10) Pub. No.: US 2025/0393074 A1
(43) Pub. Date: Dec. 25, 2025

(54) ELECTRONIC DEVICE FOR TRANSMITTING DATA THROUGH PLURALITY OF LINKS, AND ELECTRONIC DEVICE OPERATING METHOD

(71) Applicant: Samsung Electronics Co., Ltd., Suwon-si, Gyeonggi-do (KR)

(72) Inventors: Jusik YUN, Suwon-si (KR); Sungbin MIN, Suwon-si (KR); Junhak LIM, Suwon-si (KR); Junyeop JUNG, Suwon-si (KR); Junsu CHOI, Suwon-si (KR)

(21) Appl. No.: 19/306,495

(22) Filed: Aug. 21, 2025

Related U.S. Application Data
(63) Continuation of application No. PCT/KR2024/095348, filed on Feb. 16, 2024.

(30) Foreign Application Priority Data
Feb. 22, 2023 (KR) 10-2023-0023761
Mar. 13, 2023 (KR) 10-2023-0032373

(51) Int. Cl. H04W 74/0816

(52) U.S. Cl. CPC H04W 74/0816

(57) ABSTRACT

An electronic device may include: at least one antenna; a communication circuit which is electrically connected to the antenna, and which transmits/receives data through at least one from among a plurality of links including a first link, a second link and a third link generated between an external electronic device and the electronic device; and a processor(s), including processing circuitry, operatively connected to the communication circuit, wherein the processor(s) may be configured to: transmit, to the external electronic device, information of the second link and the third link through the first link when operating in an operation mode in which data cannot be received through the second link, while data is transmitted to the external electronic device through the first link; receive, from the external electronic device, through the third link, information indicating that data transmission is available through the second link, while the data is transmitted to the external electronic device through the first link; and transmit data to the external electronic device through the second link. Other embodiments are possible.

### CROSS-REFERENCE TO RELATED APPLICATIONS

This application is a continuation application of International Application No. PCT/KR2024/095348 designating the United States, filed on Feb. 16, 2024, in the Korean Intellectual Property Receiving Office and claiming priority to Korean Patent Application No. 10-2023-0023761, filed on Feb. 22, 2023, and Korean Patent Application No. 10-2023-0032373, filed on Mar. 13, 2023, the disclosures of which are all hereby incorporated by reference herein in their entireties.

### TECHNICAL FIELD

Certain example embodiments may relate to an electronic device and/or a method of operating the electronic device, and for example, to an electronic device for transmitting data through at least a plurality of links.

### BACKGROUND

With the spread of various electronic devices, the speed of wireless communication that may be used by various electronic devices has been improved. Among wireless communications supported by recent electronic devices, IEEE 802.11 WLAN (or Wi-Fi) is a standard for implementing high-speed wireless connections in various electronic devices. The first implemented Wi-Fi could support a transmission speed of for example a maximum 1 to 9 Mbps, but Wi-Fi 6 technology (or IEEE 802.11 ax) may support a transmission speed of for example a maximum of about 10 Gbps.

Electronic devices may support various services (e.g., UHD video streaming service, augmented reality (AR) service, virtual reality (VR) service, or mixed reality (MR) service) using relatively large amounts of data through wireless communications supporting high transmission speeds, and support various other services.

The IEEE 802.11 WLAN standard, or the like, is expected to introduce technology that supports a multi-link operation (MLO) in order to improve the speed of data transmission and reception and reduce latency. It is expected that electronic devices that support a multi-link operation may implement relatively high transmission speeds and low latency because they may transmit or receive data through a plurality of links.

In order to prevent or reduce chances of a situation in which a collision occurs when an electronic device simultaneously transmits data to another electronic device through the same link in a wireless LAN system, the electronic device may utilize a carrier sense multiple access with collision avoidance (CSMA/CA) scheme. The CSMA/CA scheme is a scheme for transmitting data when a specific link is in an idle state, and an electronic device supporting CSMA/CA may identify whether another electronic device transmits data through a specific link, and transmit data in the case that the another electronic device does not transmit data through the specific link. The electronic device supporting a multi-link operation may transmit data through the CSMA/CA scheme for each of a plurality of links.

The IEEE 802.11 WLAN standard is considering a method of supporting a non-STR mode or enhanced multi-link single radio (EMLSR) mode, which is a mode in which when data is transmitted to an external electronic device through one link, data is not received through another link, considering that interference occurs between links due to limitations in a mounting space of electronic devices.

### SUMMARY

An electronic device may determine whether a specific link is in an idle state in order to transmit data through the specific link. In response to identifying that the specific link is in an idle state, the electronic device may transmit data through the specific link. In order to determine whether the specific link is in an idle state, the electronic device may identify whether there is data transmitted and/or received through the specific link. The electronic device may monitor a signal transmitted through the specific link, and in the case that there is no transmitted signal, the electronic device may determine that the specific link is in an idle state, and perform a series of operations for transmitting data through the specific link.

However, an electronic device operating in a non-STR mode or EMLSR mode cannot receive data through a specific link in a state of transmitting data through another link, in which case it may be difficult that the electronic device identifies whether there is data transmitted and/or received through the specific link. The electronic device may not perform data transmission through the specific link because it may not identify whether the specific link is in an idle state, and the above situation may cause a phenomenon in which latency of data transmission increases.

An electronic device according to an example embodiment may include at least one antenna. The electronic device may include a communication circuit electrically connected, directly or indirectly, to the antenna and configured to transmit and receive data through at least one link among a plurality of links including a first link, a second link, and a third link generated between an external electronic device and the electronic device. The electronic device may include a at least one processor, comprising processing circuitry, operatively connected, directly or indirectly, to the communication circuit. When the at least one processor may individually and/or collectively operate in an operation mode in which data may not be received through the second link while transmitting data to the external electronic device through the first link, the at least one processor may individually and/or collectively transmit information of the second link and the third link to the external electronic device through the first link. While transmitting data to the external electronic device through the first link, the at least one processor may individually and/or collectively receive, from the external electronic device through the third link, information indicating that data transmission is possible through the second link. The at least one processor may be configured to, individually and/or collectively, transmit data to the external electronic device through the second link.

An electronic device according to an example embodiment may include at least one antenna. The electronic device may include a communication circuit electrically connected, directly or indirectly, to the antenna and configured to transmit and receive data through at least one link among a plurality of links including a first link, a second link, and a third link generated between an external electronic device and the electronic device. The electronic device may include a processor operatively connected, directly or indirectly, to the communication circuit. The processor may receive information of the second link and the third link through the first link. The processor may identify that the external electronic device operates in an operation mode in which it may not receive data through the second link while transmitting data to the electronic device through the first link based on information of the second link. The processor may identify a state of the second link while receiving data from the external electronic device through the first link. If the processor identifies that the state of the second link is in an idle state, the processor may transmit information indicating that data transmission is possible through the second link to the external electronic device through the third link. The processor may be configured to receive data from the external electronic device through the second link.

A method of operating an electronic device according to an example embodiment may include transmitting information of a second link and a third link to an external electronic device through the first link when the electronic device operates in an operating mode in which data may not be received through the second link while transmitting data to the external electronic device through the first link. The method of operating the electronic device may include receiving, from the external electronic device through the third link, information indicating that data transmission is possible through the second link, while transmitting data to the external electronic device through the first link. The method of operating the electronic device may include transmitting data to the external electronic device through the second link.

An electronic device and/or a method of operating the electronic device according to an example embodiment may receive a signal indicating that data transmission is possible through at least a second link through a third link having an STR relationship with the second link. The electronic device may transmit data through at least the second link while transmitting data through at least the first link upon receiving a signal indicating that data transmission is possible through the second link. Accordingly, the electronic device may receive a signal indicating that data transmission is possible through the second link through the third link and perform data transmission through the second link in a situation where a state of the second link may not be identified according to operation in a non-STR mode or an EMLSR mode, thereby improving a data transmission speed and reducing latency.

### BRIEF DESCRIPTION OF DRAWINGS

FIG. 1 is a block diagram illustrating an electronic device according to an example embodiment.

FIG. 2 is a block diagram illustrating a program according to an example embodiment.

FIG. 3 is a diagram illustrating an example embodiment in which an electronic device and an access point (AP) operate in a multi-link operation (MLO) according to an example embodiment.

FIG. 4A is a diagram illustrating an example embodiment in which an electronic device performs medium synchronization of a link according to an example embodiment.

FIG. 4B is a diagram illustrating an example embodiment in which an electronic device operates in a non-simultaneous transmission and reception (STR) mode according to an example embodiment.

FIG. 4C is a diagram illustrating an example embodiment in which an electronic device operates in an enhanced multi-link with single radio (EMLSR) mode according to an example embodiment.

FIG. 4D is a diagram illustrating a situation in which an electronic device may not transmit data of a specific link when operating in a non-STR or EMLSR mode according to an example embodiment.

FIG. 5 is a block diagram illustrating an electronic device according to an example embodiment.

FIG. 6 is a block diagram illustrating an external electronic device according to an example embodiment.

FIG. 7 is a diagram illustrating an example embodiment in which an electronic device receives information indicating that transmission of data is possible through a second link through a third link according to an example embodiment.

FIG. 8 is a flowchart illustrating a method of operating an electronic device according to an example embodiment.

FIG. 9 is a flowchart illustrating a method of operating an electronic device according to an example embodiment.

### DETAILED DESCRIPTION

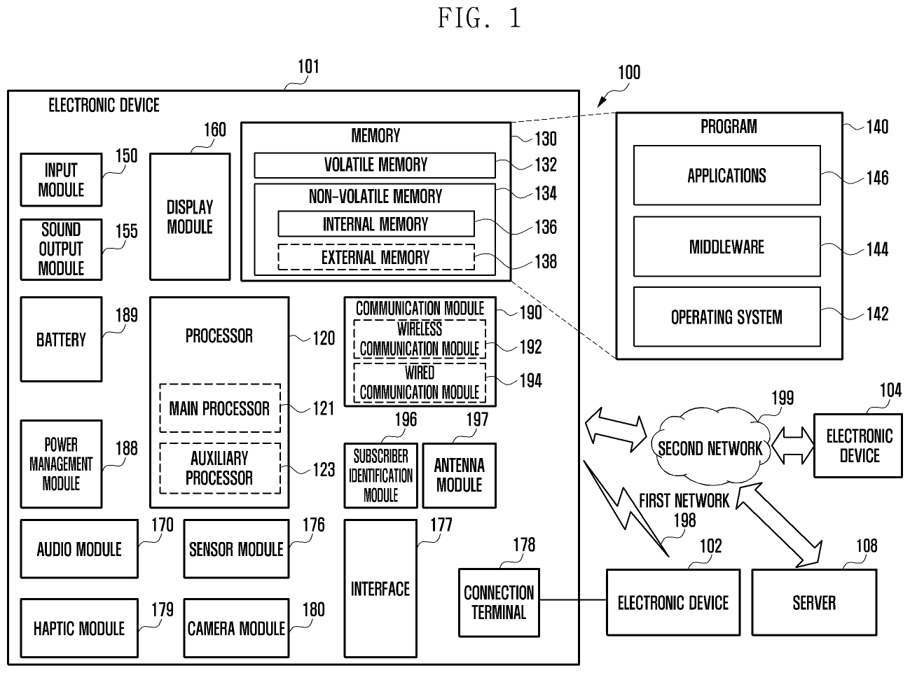

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module(SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120, comprising processing circuitry, may include a main processor 121 (e.g., a central processing unit (CPU) and/or an application processor (AP)), and/or an auxiliary processor 123 (e.g., a graphics processing unit (GPU), a neural processing unit (NPU), an image signal processor (ISP), a sensor hub processor, and/or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121. Thus, each “processor” herein may comprise processing circuitry.

The auxiliary processor 123, comprising processing circuitry, may control at least some of functions or states related to at least one component (e.g., the display module 160, the sensor module 176, and/or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor and/or a communication processor) may be implemented as part of another component (e.g., the camera module 180 and/or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 and/or the sensor module 176) of the electronic device 101. The various data may include, for example, software (e.g., the program 140) and input data or output data for a command related thereto. The memory 130 may include the volatile memory 132 and/or the non-volatile memory 134.

The program 140 may be stored in the memory 130 as software, and may include, for example, an operating system (OS) 142, middleware 144, and/or an application 146.

The input module 150 may receive a command and/or data to be used by another component (e.g., the processor 120) of the electronic device 101, from the outside (e.g., a user) of the electronic device 101. The input module 150 may include, for example, a microphone, a mouse, a keyboard, a key (e.g., a button), and/or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, and/or a projector and control circuitry to control a corresponding one of the display, hologram device, and projector. According to an embodiment, the display module 160 may include a touch sensor adapted to detect a touch, and/or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power and/or temperature) of the electronic device 101 or an environmental state (e.g., a state of a user) external to the electronic device 101, and then generate an electrical signal and/or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, and/or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration and/or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190, comprising communication circuitry, may include one or more communication processors that are operable independently from the processor 120 (e.g., the application processor (AP)) and supports a direct (e.g., wired) communication or a wireless communication. According to an embodiment, the communication module 190 may include a wireless communication module 192 comprising communication circuitry (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

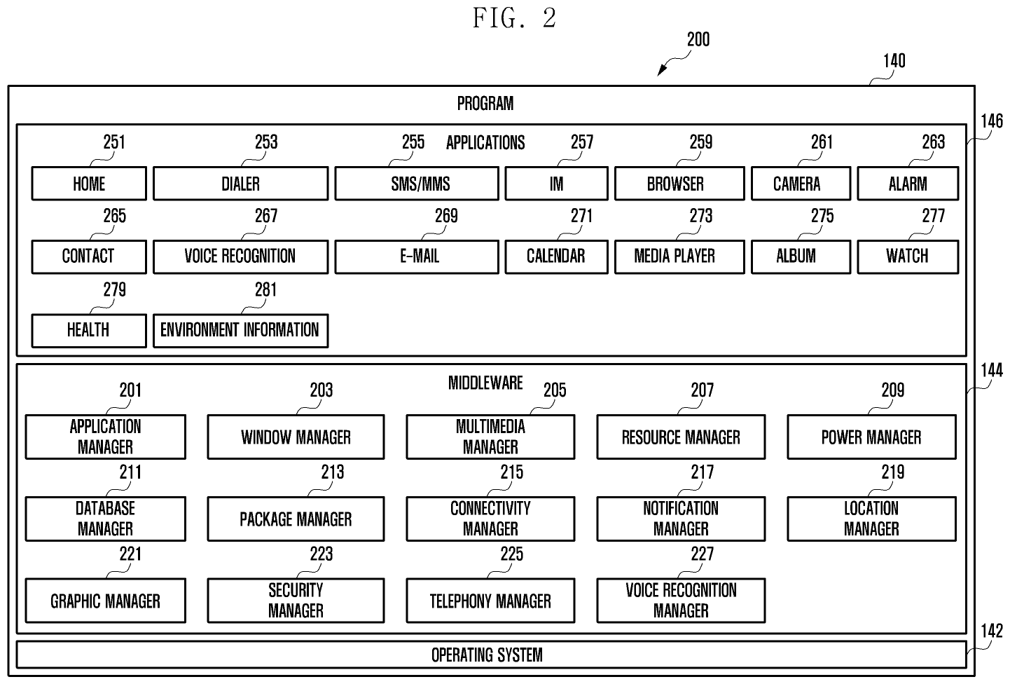

FIG. 2 is a block diagram 200 illustrating the program 140 according to various embodiments. According to an embodiment, the program 140 may include an operating system (OS) 142 to control one or more resources of the electronic device 101, middleware 144, or an application 146 executable in the OS 142. The OS 142 may include, for example, Android™, iOS™, Windows™, Symbian™, Tizen™, or Bada™. At least part of the program 140, for example, may be pre-loaded on the electronic device 101 during manufacture, or may be downloaded from or updated by an external electronic device (e.g., the electronic device 102 or 104, or the server 108) during use by a user.

The OS 142 may control management (e.g., allocating or deallocation) of one or more system resources (e.g., process, memory, or power source) of the electronic device 101. The OS 142, additionally or alternatively, may include one or more driver programs to drive other hardware devices of the electronic device 101, for example, the input module 150, the sound output module 155, the display module 160, the audio module 170, the sensor module 176, the interface 177, the haptic module 179, the camera module 180, the power management module 188, the battery 189, the communication module 190, the subscriber identification module 196, or the antenna module 197.

The middleware 144 may provide various functions to the application 146 such that a function or information provided from one or more resources of the electronic device 101 may be used by the application 146. The middleware 144 may include, for example, an application manager 201, a window manager 203, a multimedia manager 205, a resource manager 207, a power manager 209, a database manager 211, a package manager 213, a connectivity manager 215, a notification manager 217, a location manager 219, a graphic manager 221, a security manager 223, a telephony manager 225, or a voice recognition manager 227.

The application manager 201, for example, may manage the life cycle of the application 146. The window manager 203, for example, may manage one or more graphical user interface (GUI) resources that are used on a screen. The multimedia manager 205, for example, may identify one or more formats to be used to play media files, and may encode or decode a corresponding one of the media files using a codec appropriate for a corresponding format selected from the one or more formats. The resource manager 207, for example, may manage the source code of the application 146 or a memory space of the memory 130. The power manager 209, for example, may manage the capacity, temperature, or power of the battery 189, and determine or provide related information to be used for the operation of the electronic device 101 based at least in part on corresponding information of the capacity, temperature, or power of the battery 189. According to an embodiment, the power manager 209 may interwork with a basic input/output system (BIOS) (not shown) of the electronic device 101.

The database manager 211, for example, may generate, search, or change a database to be used by the application 146. The package manager 213, for example, may manage installation or update of an application that is distributed in the form of a package file. The connectivity manager 215, for example, may manage a wireless connection or a direct connection between the electronic device 101 and the external electronic device. The notification manager 217, for example, may provide a function to notify a user of an occurrence of a specified event (e.g., an incoming call, message, or alert). The location manager 219, for example, may manage locational information on the electronic device 101. The graphic manager 221, for example, may manage one or more graphic effects to be offered to a user or a user interface related to the one or more graphic effects.

The security manager 223, for example, may provide system security or user authentication. The telephony manager 225, for example, may manage a voice call function or a video call function provided by the electronic device 101. The voice recognition manager 227, for example, may transmit a user's voice data to the server 108, and receive, from the server 108, a command corresponding to a function to be executed on the electronic device 101 based at least in part on the voice data, or text data converted based at least in part on the voice data. According to an embodiment, the middleware 244 may dynamically delete some existing components or add new components. According to an embodiment, at least part of the middleware 144 may be included as part of the OS 142 or may be implemented as another software separate from the OS 142.

The application 146 may include, for example, a home 251, dialer 253, short message service (SMS)/multimedia messaging service (MMS) 255, instant message (IM) 257, browser 259, camera 261, alarm 263, contact 265, voice recognition 267, email 269, calendar 271, media player 273, album 275, watch 277, health 279 (e.g., for measuring the degree of workout or biometric information, such as blood sugar), or environmental information 281 (e.g., for measuring air pressure, humidity, or temperature information) application. According to an embodiment, the application 146 may further include an information exchanging application (not shown) that is capable of supporting information exchange between the electronic device 101 and the external electronic device. The information exchange application, for example, may include a notification relay application adapted to transfer designated information (e.g., a call, message, or alert) to the external electronic device or a device management application adapted to manage the external electronic device. The notification relay application may transfer notification information corresponding to an occurrence of a specified event (e.g., receipt of an email) at another application (e.g., the email application 269) of the electronic device 101 to the external electronic device. Additionally or alternatively, the notification relay application may receive notification information from the external electronic device and provide the notification information to a user of the electronic device 101.

The device management application may control the power (e.g., turn-on or turn-off) or the function (e.g., adjustment of brightness, resolution, or focus) of the external electronic device or some component thereof (e.g., a display module or a camera module of the external electronic device). The device management application, additionally or alternatively, may support installation, delete, or update of an application running on the external electronic device.

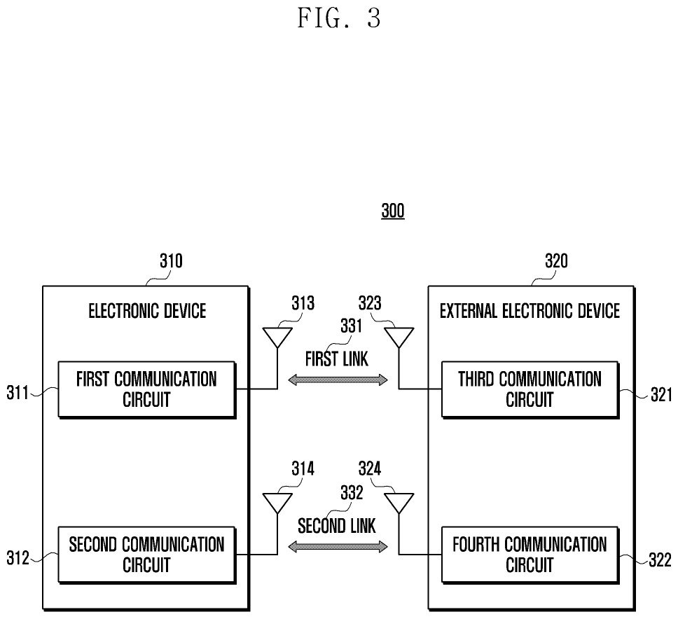

FIG. 3 is a diagram illustrating an embodiment in which an electronic device and an external electronic device (e.g., access point (AP)) operate in a multi-link operation (MLO) according to an embodiment.

With reference to FIG. 3, a wireless LAN system 300 may include an electronic device 310 and/or an external electronic device 320. According to an embodiment, the electronic device 310 may perform wireless communication with the external electronic device 320 through short-range wireless communication. Wireless communication may mean various communication methods in which both the electronic device 310 and/or the external electronic device 320 may support. For example, wireless communication may be Wi-Fi. The external electronic device 320 may perform the role of a base station that provides wireless communication to at least one electronic device 310 positioned inside a communication radius of the wireless LAN system 300. For example, the external electronic device 320 may include an access point (AP) of IEEE 802.11. The electronic device 310 may include a station (STA) of IEEE 802.11.

According to an embodiment, the electronic device 310 and/or the external electronic device 320 may support a multi-link operation (MLO). The multi-link operation may be an operation mode for transmitting or receiving data through a plurality of links (e.g., a first link 331, a second link 332). The multi-link operation may be an operation mode for transmitting or receiving data through a plurality of links based on a plurality of bands or channels as an operation mode to be introduced in IEEE 802.11be.

According to an embodiment, the electronic device 310 may include a plurality of communication circuits (e.g., a first communication circuit 311 and/or a second communication circuit 312) in order to support a multi-link operation. The first communication circuit 311 may transmit data to the external electronic device 320 through the first link 331 or receive data transmitted by the external electronic device 320 through the first link 331. The first communication circuit 311 may output or receive a signal of a frequency band corresponding to the first link 331 through a first antenna 313. The second communication circuit 312 may transmit data to the external electronic device 320 through the second link 332 or receive data transmitted by the external electronic device 320 through the second link 332. The second communication circuit 312 may output or receive a signal of a frequency band corresponding to the second link 332 through a second antenna 314.

According to an embodiment, the external electronic device 320 may include a plurality of communication circuits (e.g., a third communication circuit 321 and/or a fourth communication circuit 322) in order to support a multi-link operation. The third communication circuit 321 may transmit data to the electronic device 310 through the first link 331 or receive data transmitted by the electronic device 310 through the first link 331. The third communication circuit 321 may output or receive a signal of a frequency band corresponding to the first link 331 through a third antenna 323. The fourth communication circuit 322 may transmit data to the electronic device 310 through the second link 332 or receive data transmitted by the electronic device 310 through the second link 332. The fourth communication circuit 322 may output or receive a signal of a frequency band corresponding to the second link 332 through a fourth antenna 324.

According to an embodiment, a frequency band of the first link 331 and a frequency band of the second link 333 may be different from each other. For example, the frequency band of the first link 331 may be 2.5 GHz, and the frequency band of the second link 332 may be 5 GHz or 6 GHz.

According to an embodiment, the first link 331 and the second link 332 may be used by electronic devices other than the electronic device 310. In order to prevent or reduce chances of a situation in which the electronic device 310 and the other electronic device transmit or receive data through the same link at the same time, the electronic device 310 may support a carrier sense multiple access with collision avoidance (CSMA/CA) scheme. The CSMA/CA scheme may be a scheme for performing data transmission when a specific link is in an idle state. The electronic device 310 supporting CSMA/CA may identify whether another electronic device transmits data through a specific link, and in the case that the electronic device 310 detects data transmission, the electronic device 310 may not transmit data through a specific link but stand by. The electronic device 310 supporting CSMA/CA may transmit data through a specific link according to a designated scheme (e.g., activating a timer and transmitting data when the timer has expired) in response to identifying that another electronic device does not transmit data through the specific link. Through the above scheme, the electronic device 310 may perform data transmission and/or reception using the specific link without colliding with other electronic devices.

According to an embodiment, the first link 331 and/or the second link 332 supported by a multi-link operation may independently support CSMA/CA.

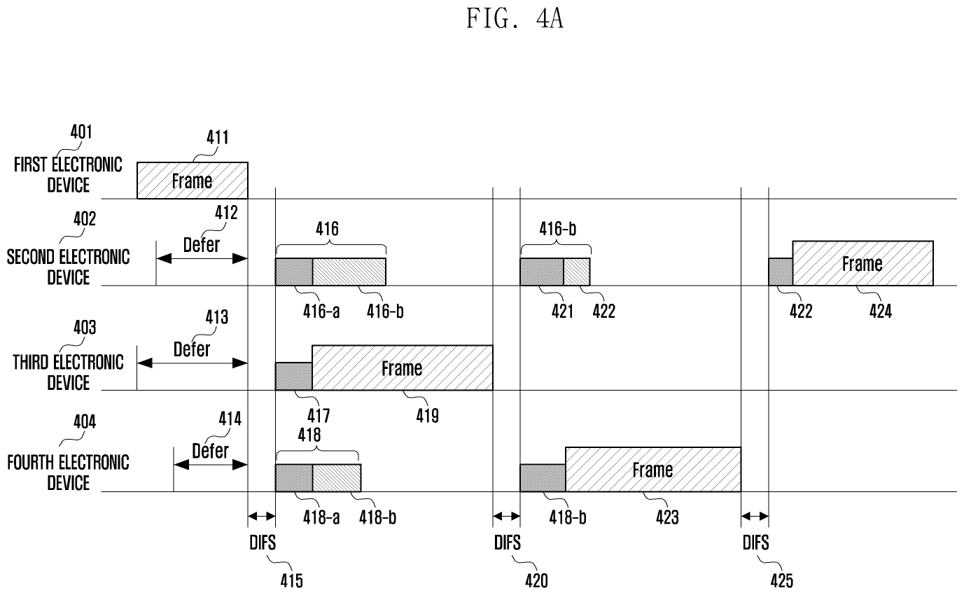

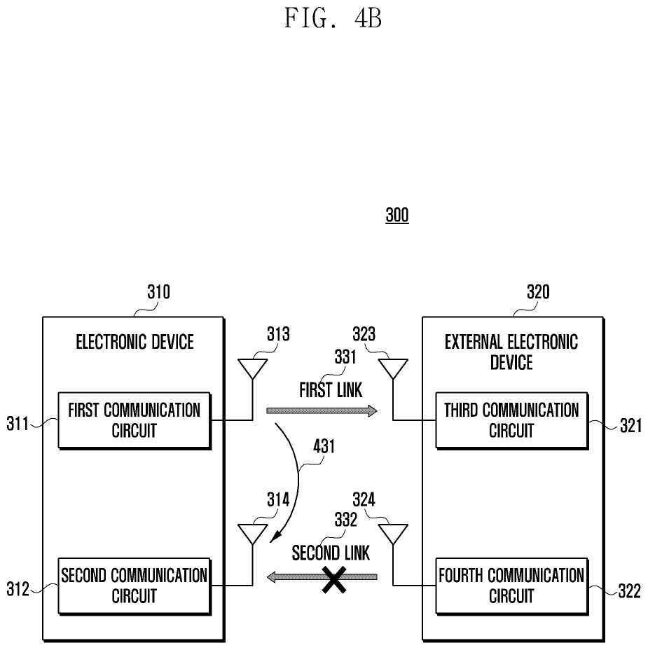

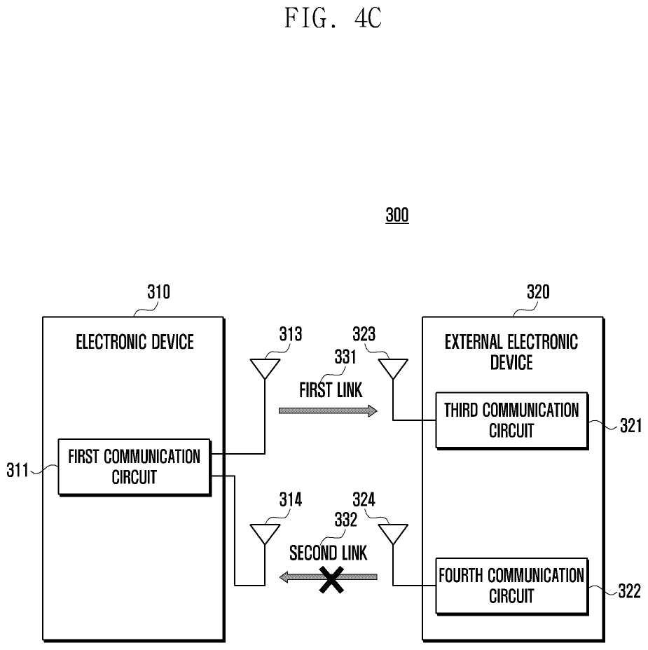

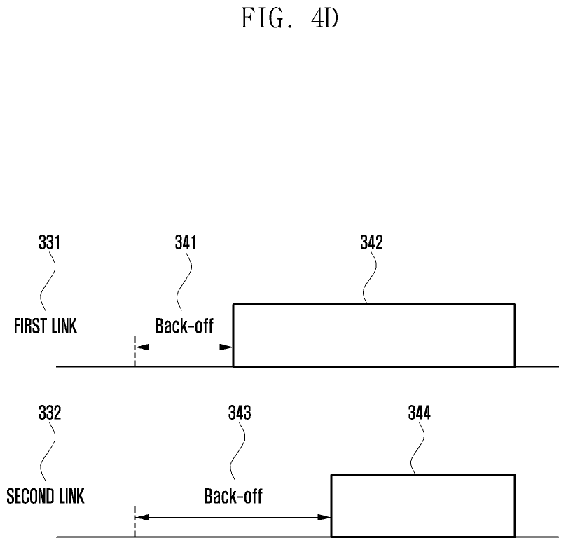

FIG. 4A is a diagram illustrating an embodiment in which an electronic device performs medium synchronization of a link according to an embodiment.

FIG. 4A illustrates an embodiment in which a first electronic device 401 (e.g., the electronic device 310 of FIG. 3), a second electronic device 402 (e.g., the electronic device 310 of FIG. 3), a third electronic device 403 (e.g., the electronic device 310 of FIG. 3), and/or a fourth electronic device 404 (e.g., the electronic device 310 of FIG. 3) transmit data to the external electronic device 320 using the same link (e.g., the second link 332 of FIG. 3).

According to an embodiment, the first electronic device 401, the second electronic device 402, the third electronic device 403, and/or the fourth electronic device 404 may perform data transmission through a CSMA/CA scheme. The first electronic device 401, the second electronic device 402, the third electronic device 403, and/or the fourth electronic device 404 may perform medium synchronization of the second link 332 before performing data transmission. Medium synchronization of the second link 332 may mean a state in which a state of the second link 332 may be updated in real time. Medium synchronization of the second link 332 may be performed using a portion of data (e.g., header of data) transmitted through the second link 332.

The first electronic device 401 supporting the CSMA/CA scheme may identify whether a specific link is in an idle state before transmitting data 411. The first electronic device 401 may identify whether the second link 332 is in an idle state based on information related to an idle state of the second link 332 included in data transmitted by the external electronic device 320. Information related to the idle state of the second link 332 may include a clear channel assessment (CCA) field and/or a network allocation vector (NAV) configuration field. Information related to the idle state of the second link 332 may be included in a ready to send (RTS) message requesting data transmission through the second link 332 and a clear to send (CTS) message indicating that data transmission is possible through the second link 332. The first electronic device 401 may identify whether a specific link is in an idle state with reference to a CCA field and/or a NAV configuration field. The first electronic device 401 may determine whether the second link 332 is physically in an idle state with reference to a CCA state field, and determine whether the second link 332 is logically in an idle state with reference to a NAV configuration field. In response to identifying that a specific link is in an idle state, the first electronic device 401 may activate a timer, and in response to the timer expiring after a designated time, the first electronic device 401 may transmit data 411 to the external electronic device 320 through the second link 332.

The second electronic device 402, the third electronic device 403, and/or the fourth electronic device 404 supporting CSMA/CA may stand by (412, 413, 414) without transmitting other data while the first electronic device 401 transmits data 411. The second electronic device 402, the third electronic device 403, and/or the fourth electronic device 404 may determine an end time of transmission of the data 411 based on a portion of the data 411 transmitted through the second link 332 (e.g., a rate field of data and/or a length field of data included in a PHY header, a duration field of data included in a MAC header), and stand by during a predetermined time 415 based on the end of transmission of the data 411.

The second electronic device 402, the third electronic device 403, and/or the fourth electronic device 404 may activate a timer after a predetermined time 415 has elapsed, and transmit data to the external electronic device 320 through the second link 332 in response to expiration of the timer. Lengths of timers configured in the second electronic device 402, the third electronic device 403, and/or the fourth electronic device 404 may be different from each other. According to an embodiment, the second electronic device 402, the third electronic device 403, and/or the fourth electronic device 404 may identify whether the timer has expired using the randomly configured timer, and transmit data when the timer has expired.

With reference to FIG. 4A, the second electronic device 402 may activate a timer in which a first period 416 is configured, the third electronic device 403 may activate a timer in which a second period 417 is configured, and the fourth electronic device 404 may activate a timer in which a third period 418 is configured. The first period 416, the second period 417, and/or the third period 418 may be different from each other. With reference to FIG. 4A, the first period 416 may be longer than the third period 418, and the third period 418 may be longer than the second period 417.

According to an embodiment, the third electronic device 403 may transmit data 419 to the external electronic device 320 through the second link 332 in response to identifying that the second period 417 has expired. The second electronic device 402 and/or the fourth electronic device 404 may stand by without transmitting other data while the third electronic device 403 transmits the data 419. The second electronic device 402 may store a remaining period 416-b obtained by subtracting an elapsed period 416-a from the first period 416, and the fourth electronic device 404 may store a remaining period 418-b obtained by subtracting an elapsed period 418-a from the third period 418. The second electronic device 402 and/or the fourth electronic device 404 may determine an end time of transmission of the data 419 based on a portion of the data 419 transmitted through the second link 332 (e.g., a rate field of data and/or a length field of data included in a PHY header, a duration field of data included in a MAC header), and stand by during a predetermined time 420 based on the end of transmission of the data 419.

The second electronic device 402 and/or the fourth electronic device 404 may reactivate the timer after a predetermined time 420 has elapsed. In response to identifying that a remaining period 418-b has expired, the fourth electronic device 404 may transmit data 423 to the external electronic device 320 through the second link 332. The second electronic device 402 may detect that the fourth electronic device 404 transmits data 423 before the remaining period 416-b expires and deactivate the operation of the timer again. The second electronic device 420 may store a remaining period 422 obtained by subtracting the elapsed period 421 from the remaining period 416-b. The second electronic device 402 may determine an end time of transmission of the data 423 based on a portion of the data 423 transmitted through the second link 332 (e.g., a rate field of data and/or a length field of data included in the PHY header, a duration field of data included in the MAC header), and stand by during a predetermined time 425 based on the end of transmission of the data 423.

The second electronic device 402 may reactivate the timer after a predetermined time 425 has elapsed. In response to identifying that a remaining period 422 has expired, the fourth electronic device 404 may transmit data 424 to the external electronic device 320 through the second link 332.

As described above, the first electronic device 401, the second electronic device 402, the third electronic device 403, and/or the fourth electronic device 404 may perform media synchronization of the second link 332.

Through the method illustrated in FIG. 4A, the first electronic device 401, the second electronic device 402, the third electronic device 403, and/or the fourth electronic device 404 supporting CSMA/CA may transmit data to the external electronic device 320 through the second link 332 without collision. The first electronic device 401, the second electronic device 402, the third electronic device 403, and/or the fourth electronic device 404 should always be able to receive or monitor data transmitted through the second link 332 in order for the CSMA/CA scheme to operate smoothly.

FIG. 4B is a diagram illustrating an embodiment in which an electronic device operates in a non-simultaneous transmission and reception (STR) mode according to an embodiment.

With reference to FIG. 4B, the wireless LAN system 300 may include an electronic device 310 and/or an external electronic device 320. According to an embodiment, the electronic device 310 may perform wireless communication with the external electronic device 320 through short-range wireless communication. Wireless communication may mean various communication methods in which both the electronic device 310 and/or the external electronic device 320 may support. For example, wireless communication may be Wi-Fi. The external electronic device 320 may perform the role of a base station that provides wireless communication to at least one electronic device 310 positioned inside a communication radius of the wireless LAN system 300. For example, the external electronic device 320 may include an access point (AP) of IEEE 802.11. The electronic device 310 may include a station (STA) of IEEE 802.11.

According to an embodiment, the electronic device 310 and/or the external electronic device 320 may support a multi-link operation (MLO). The multi-link operation may be an operation mode for transmitting or receiving data through a plurality of links (e.g., a first link 331, a second link 332). The multi-link operation may be an operation mode for transmitting or receiving data through a plurality of links based on a plurality of bands or channels as an operation mode to be introduced in IEEE 802.11be.

According to an embodiment, the electronic device 310 may include a plurality of communication circuits (e.g., a first communication circuit 311 and/or a second communication circuit 312) in order to support a multi-link operation. The first communication circuit 311 may transmit data to the external electronic device 320 through the first link 331 or receive data transmitted by the external electronic device 320 through the first link 331. The first communication circuit 311 may output or receive a signal of a frequency band corresponding to the first link 331 through a first antenna 313. The second communication circuit 312 may transmit data to the external electronic device 320 through a second link 332 or receive data transmitted by the external electronic device 320 through the second link 332. The second communication circuit 312 may output or receive a signal of a frequency band corresponding to the second link 332 through a second antenna 314.

According to an embodiment, the external electronic device 320 may include a plurality of communication circuits (e.g., a third communication circuit 321 and/or a fourth communication circuit 322) in order to support a multi-link operation. The third communication circuit 321 may transmit data to the electronic device 310 through the first link 331 or receive data transmitted by the electronic device 310 through the first link 331. The third communication circuit 321 may output or receive a signal of a frequency band corresponding to the first link 331 through a third antenna 323. The fourth communication circuit 322 may transmit data to the electronic device 310 through the second link 332 or receive data transmitted by the electronic device 310 through the second link 332. The fourth communication circuit 322 may output or receive a signal of a frequency band corresponding to the second link 332 through a fourth antenna 324.

According to an embodiment, the frequency band of the first link 331 and the frequency band of the second link 333 may be different from each other. For example, the frequency band of the first link 331 may be 2.5 GHz, and the frequency band of the second link 332 may be 5 GHz.

According to an embodiment, the electronic device 310 may not sufficiently secure a space 431 between the first antenna 313 and the second antenna 314 due to implementation reasons. According to an embodiment, in the case that the space 431 between the first antenna 313 and the second antenna 314 is not sufficiently secured, interference may occur between a signal output by the first antenna 313 and a signal received through the second antenna 314. For example, the second antenna 314 may receive a combined signal of a portion of a signal output by the first antenna 313 and a signal received through the second link 332; thus, a quality of the signal received through the second link 332 may be deteriorated.

According to an embodiment, the electronic device 310 may support a non-simultaneous transmission and reception (STR) mode in order to prevent or reduce chances of a situation in which interference occurs between a signal output from the first antenna 313 and a signal output from the second antenna 314. The non-STR mode may mean a mode in which the electronic device 310 does not receive data through the second link 332 when transmitting data to the external electronic device 320 through the first link 331. The non-STR mode may support an operation of receiving data through the second link 332 while receiving data through the first link 331 and/or an operation of transmitting data through the second link 332 while transmitting data through the first link 331.

According to an embodiment, the electronic device 310 operating in a non-STR mode may not receive data through the second link 332 in the case of transmitting data to an external electronic device 320 through the first link 331. Because the electronic device 310 may not receive data through the second link 332, the electronic device 310 may be placed in a state where it may not perform media synchronization of the second link 332 that may be performed using a portion of data. In this case, the electronic device 310 may not identify whether another electronic device (e.g., the second electronic device 402, the third electronic device 403, and/or the fourth electronic device 404) transmits data through the second link 332, and in order to transmit data through the second link 332, after a designated time (e.g., time out) has expired, the electronic device 310 may activate again the timer, and after the timer has expired, the electronic device 310 transmits data; thus, latency of the data transmission may increase.

FIG. 4C is a diagram illustrating an embodiment in which an electronic device operates in an enhanced multi-link with single radio (EMLSR) mode according to an embodiment.

With reference to FIG. 4C, a wireless LAN system 300 may include an electronic device 310 and/or an external electronic device 320. According to an embodiment, the electronic device 310 may perform wireless communication with the external electronic device 320 through short-range wireless communication. Wireless communication may mean various communication methods in which both the electronic device 310 and/or the external electronic device 320 may support. For example, wireless communication may be Wi-Fi. The external electronic device 320 may perform the role of a base station that provides wireless communication to at least one electronic device 310 positioned inside a communication radius of the wireless LAN system 300. For example, the external electronic device 320 may include an access point (AP) of IEEE 802.11. The electronic device 310 may include a station (STA) of IEEE 802.11.

According to an embodiment, the electronic device 310 and/or the external electronic device 320 may support a multi-link operation (MLO). The multi-link operation may be an operation mode for transmitting and/or receiving data through a plurality of links (e.g., a first link 331, a second link 332). The multi-link operation may be an operation mode for transmitting and/or receiving data through a plurality of links based on a plurality of bands and/or channels as an operation mode to be introduced in IEEE 802.11be.

According to an embodiment, the electronic device 310 may include a first communication circuit 311 in order to support a multi-link operation. The first communication circuit 311 may transmit data to the external electronic device 320 through the first link 331 and/or receive data transmitted by the external electronic device 320 through the first link 331. The first communication circuit 311 may transmit data to the external electronic device 320 through the second link 332, and/or receive data transmitted by the external electronic device 320 through the second link 332. The first communication circuit 311 may output or receive a signal of a frequency band corresponding to the first link 331 through a first antenna 313, and output or receive a signal of a frequency band corresponding to the second link 332 through a second antenna 314. “Or” as used herein covers and/or.

According to an embodiment, the external electronic device 320 may include a plurality of communication circuits (e.g., a third communication circuit 321 and/or a fourth communication circuit 322) in order to support a multi-link operation. The third communication circuit 321 may transmit data to the electronic device 310 through the first link 331 or receive data transmitted by the electronic device 310 through the first link 331. The third communication circuit 321 may output or receive a signal of a frequency band corresponding to the first link 331 through a third antenna 323. The fourth communication circuit 322 may transmit data to the electronic device 310 through the second link 332 or receive data transmitted by the electronic device 310 through the second link 332. The fourth communication circuit 322 may output or receive a signal of a frequency band corresponding to the second link 332 through a fourth antenna 324.

According to an embodiment, the frequency band of the first link 331 and the frequency band of the second link 333 may be different from each other. For example, the frequency band of the first link 331 may be 2.5 GHz, and the frequency band of the second link 332 may be 5 GHz.

According to an embodiment, the electronic device 310 may support a multi-link operation using a plurality of links using one communication circuit (e.g., the first communication circuit 311) due to implementation reasons. In this case, the electronic device 310 may perform an enhanced multi-link single radio (EMLSR) mode in which data having a relatively small size (e.g., control data, RTS frame, CTS frame, ACK message) are transmitted using a plurality of links (e.g., the first link 331 and the second link 332) and in which data having a relatively large size are transmitted using a single link (e.g., the first link 331). The EMLSR mode may mean a mode in which data having a relatively small size are transmitted and received using a plurality of links and in which data having a relatively large size are transmitted and received using a single link. The electronic device 310 operating in an EMLSR mode may not receive data through the second link 332 in the case of transmitting data having a relatively large size to the external electronic device 320 through the first link 331.

The electronic device 310 may be placed in a state where it may not perform media synchronization of the second link 332 that may be performed using a portion of data, by not receiving data through the second link 332. In this case, the electronic device 310 may not identify whether another electronic device (e.g., the second electronic device 402, the third electronic device 403, and/or the fourth electronic device 404) transmits data through the second link 332, and in order to transmit data through the second link 332, after a designated time (e.g., time out) has expired, the electronic device 310 may activate again a timer, and after the timer has expired, the electronic device 310 may transmit data; thus, latency of data transmission may increase.

FIG. 4D is a diagram illustrating a situation in which an electronic device may not transmit data of a specific link when operating in a non-STR or EMLSR mode according to an embodiment.

With reference to FIG. 4D, the electronic device (e.g., the electronic device 310 of FIG. 3) may be connected to an external electronic device (e.g., the external electronic device 320 of FIG. 3) through a first link (e.g., the first link 331 of FIG. 3) and a second link (e.g., the second link 332 of FIG. 3). The electronic device 310 may transmit and/or receive data to and from the external electronic device 320 through the first link 331 and/or the second link 332.

According to an embodiment, the electronic device 310 may support a non-STR mode or an EMLSR mode in order to prevent or reduce chances of a situation in which interference occurs between a signal output from a first antenna (e.g., the first antenna 313 of FIG. 3) and a signal output from a second antenna (e.g., the second antenna 314 of FIG. 3).

The non-STR mode may mean a mode in which the electronic device 310 does not receive data through the second link 332 when transmitting data to the external electronic device 320 through the first link 331. The non-STR mode may support an operation of receiving data through the second link 332 while receiving data through the first link 331 and/or an operation of transmitting data through the second link 332 while transmitting data through the first link 331.

The EMLSR mode may mean a mode in which data having a relatively small size are transmitted and received using a plurality of links and in which data having a relatively large size are transmitted and received using one link. The electronic device 310 operating in the EMLSR mode may not receive data through the second link 332 in the case of transmitting data having a relatively large size to the external electronic device 320 through the first link 331.

According to an embodiment, the electronic device 310 operating in a non-STR mode or an EMLSR mode may not receive data through the second link 332 in the case of transmitting data to the external electronic device 320 through the first link 331. Because the electronic device 310 may not receive data through the second link 332, the electronic device 310 may be placed in a state where it may not perform media synchronization of the second link 332 that may be performed using a portion of data.

With reference to FIG. 4D, the electronic device 310 may transmit data 342 to the external electronic device 320 through the first link 331 after a time (back-off) 341 configured in the timer of the first link 331 has expired or after the configured time 341 has expired and a predetermined time (e.g., short inter-frame space (SIFS)) has elapsed.

The electronic device 310 may not receive data through the second link 332 while transmitting data 342 through the first link 331. The electronic device 310 may not receive data (or signal) through the second link 332 due to an interference phenomenon caused by transmission of data through the first link 331. The electronic device 310 may not identify the state of the second link 332 by not receiving data through the second link 332. According to an embodiment, the electronic device 310 may identify whether the second link 332 is in an idle state or an occupied state (or busy state) by monitoring a signal transmitted (or broadcasted) through the second link 332. The electronic device 310 may not identify the state of the second link 332 by not monitoring a signal transmitted (or broadcasted) through the second link 332. The electronic device 310 may not perform an activation operation of a timer (e.g., an operation of determining whether a time (back-off) 343 configured in the timer has expired) that should be performed after identifying that the second link 332 is in an idle state; thus, a phenomenon may occur in which data 344 transmission is not performed through the second link 332.

Hereinafter, an example is described that allows data 344 to be transmitted through the second link 332 while transmitting data 342 through the first link 331 while the electronic device 310 operates in a non-STR mode or EMLSR mode.

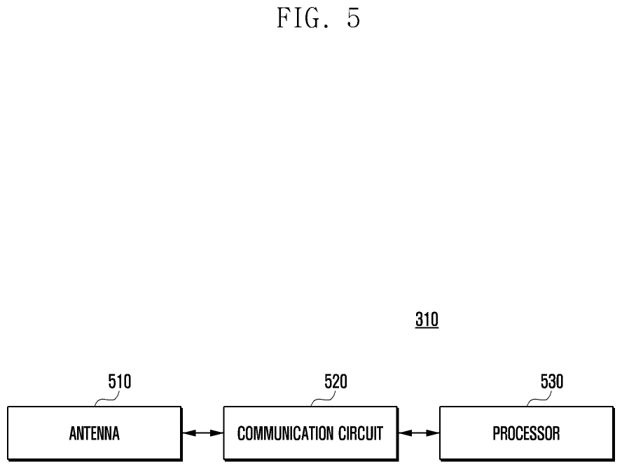

FIG. 5 is a block diagram illustrating an electronic device according to an embodiment.

According to an embodiment, the electronic device 310 may include an antenna 510, a communication circuit 520 (e.g., the first communication circuit 311 or the second communication circuit 312 of FIG. 4B), and/or a processor 530 (e.g., the processor 120 of FIG. 1).

According to an embodiment, the antenna 510 may receive a signal transmitted by an external electronic device (e.g., the external electronic device 320 of FIG. 3), or transmit a signal to the external electronic device 320. In the case that the electronic device 310 supports an MLO, the electronic device 310 may transmit or receive a signal of a frequency band corresponding to a first link (e.g., the first link 331 of FIG. 3) and transmit or receive a signal of a frequency band corresponding to a second link (e.g., the second link 332 of FIG. 3). The antenna 510 may be implemented into a plurality of antennas.

The communication circuit 520 may transmit data to the external electronic device 320 through the first link 331, or receive data transmitted by the external electronic device 320 through the first link 331. The communication circuit 520 may transmit data to the external electronic device 320 through the second link 332, or receive data transmitted by the external electronic device 320 through the second link 332. The communication circuit 520 may output or receive a signal of a frequency band corresponding to the first link 331 through the antenna 510, and may output or receive a signal of a frequency band corresponding to the second link 332 through the antenna 510.

The processor 530 may be operatively connected, directly or indirectly, to the communication circuit 520 to control the operation of the communication circuit 520.

The processor 530 may identify whether the first link 331 is in an idle state in order to transmit data through the first link 331. The processor 530 may identify whether the first link 331 is in an idle state with reference to a clear channel assessment (CCA) status field and/or a network allocation vector (NAV) configuration field of data transmitted through the first link 331. Specifically, the processor 530 may determine whether the first link 331 is physically in an idle state with reference to the CCA status field, and determine whether the first link 331 is logically in an idle state with reference to the NAV configuration field. As the processor 530 identifies that the first link 331 is in an idle state, the processor 530 may activate a first timer for transmission of the first link 331. The first timer may be a timer to be used for media synchronization of the first link 331. As the first timer for transmission of the first link 331 has expired, the processor 530 may control the communication circuit 520 to transmit data to the external electronic device 320 through the first link 331.

The processor 530 may identify whether the second link 332 is in an idle state in order to transmit data through the second link 332. The processor 530 may determine whether the second link 332 is in an idle state using information related to the idle state of the second link 332 included in data transmitted through the second link 332. Information related to the idle state of the second link 332 may include a clear channel assessment (CCA) status field and/or a network allocation vector (NAV) configuration field.

The processor 530 may identify whether the second link 332 is in an idle state with reference to the CCA status field and/or the NAV configuration field of data transmitted through the second link 332. Specifically, the processor 530 may determine whether the second link 332 is physically in an idle state with reference to the CCA status field, and determine whether the second link 332 is logically in an idle state with reference to the NAV configuration field. As the processor 530 identifies that the second link 332 is in an idle state, the processor 530 may activate a second timer for transmission of the second link 332. As the second timer for transmission of the second link 332 has expired, the processor 530 may control the communication circuit 520 to transmit data to the external electronic device 320 through the second link 332.

The processor 530 may control the communication circuit 520 to transmit data to the external electronic device 320 using a non-STR mode or an EMLSR mode among modes supported by the multi-link operation.

In the case that the state of the electronic device 310 satisfies a designated condition while the electronic device 310 operates in a non-STR mode or an EMLSR mode, the processor 530 may determine to activate a mode capable of receiving information indicating that data transmission is possible through the second link 332 through the third link, which is a link having an STR relationship with the second link 332. The third link, which is a link having an STR relationship with the second link 332, may refer to a link capable of receiving data through the third link while transmitting data through the second link 332 or a link capable of receiving data through the second link 332 while transmitting data through the third link.

According to an embodiment, the designated condition may include a condition for performing a service requiring low latency. As the processor 530 detects that an application performing a service requiring low latency is executed, the processor 530 may determine to activate a mode capable of receiving information indicating that data transmission is possible through the second link 332 through the third link, which is a link having an STR relationship with the second link 332.

According to an embodiment, the designated condition may include a condition that the external electronic device 320 supports a mode capable of transmitting information indicating that data transmission is possible through the second link 332 through the third link, which is a link having an STR relationship with the second link 332. As the processor 530 identifies that the external electronic device 320 supports a mode capable of transmitting information indicating that data transmission is possible through the second link 332 through the third link, which is a link having an STR relationship with the second link 332, the processor 530 may determine to activate a mode capable of receiving information indicating that data transmission is possible through the second link 332 through the third link, which is a link having an STR relationship with the second link 332. According to an embodiment, the processor 530 may receive, from the external electronic device 320, information indicating support of a mode capable of transmitting information indicating that data transmission is possible through the second link 332 through the third link, which is a link having an STR relationship with the second link 332. Information indicating support of a mode capable of transmitting information indicating that data transmission is possible through the second link 332 through the third link, which is a link having an STR relationship with the second link 332 may be included in a vendor specific action frame defined in IEEE 802.11. The vendor specific action frame may include a field (vendor specific content) including information added by a vendor, and information indicating support of a mode capable of transmitting information indicating that data transmission is possible through the second link 332 through the third link, which is a link having an STR relationship with the second link 332 may be included in a field (vendor specific content) including information added by the vendor.

As the processor 530 activates a mode capable of transmitting information indicating that data transmission is possible through the second link 332 through the third link, which is a link having an STR relationship with the second link 332, the processor 530 may activate the third link or maintain an activated state of the third link in the case that the third link is already activated.

As the processor 530 activates a mode capable of transmitting information indicating that data transmission is possible through the second link 332 through the third link, which is a link having an STR relationship with the second link 332, the processor 530 may transmit, to the external electronic device 320, information indicating activation of a mode capable of transmitting information indicating that data transmission is possible through the second link 332 through the third link, which is a link having an STR relationship with the second link 332. The processor 530 may transmit, to the external electronic device 320 through the first link 331, information indicating activation of a mode (hereinafter, defined to a specific mode) capable of transmitting information indicating that data transmission is possible through the second link 332 through the third link, which is a link having an STR relationship with the second link 332.

Information indicating an operation in a specific mode may include information indicating links having a non-STR relationship. Links having a non-STR relationship may refer to links that cannot receive data through another link while transmitting data through one link. According to an embodiment, in the case that the electronic device 310 cannot receive data through the second link 332 while transmitting data through the first link 331, information indicating an operation in a specific mode may include information on the first link 331 and information on the second link 332. According to an embodiment, the information on the first link 331 may include channel information of the first link 331, identification information of the first link 331, address information of a medium access control (MAC) corresponding to the first link 331, and a transmission period of a beacon transmitted through the first link 331. According to an embodiment, the information on the second link 332 may include channel information of the second link 332, identification information of the second link 332, address information of a MAC corresponding to the second link 332, and a transmission period of a beacon transmitted through the second link 332.

Information indicating an operation in a specific mode may include information indicating links having an STR relationship. Links having an STR relationship may refer to links capable of receiving data through another link while transmitting data through one link. According to an embodiment, in the case that the electronic device 310 may receive data through the third link while transmitting data through the first link 331 or the second link 332, the third link may have an STR relationship with the first link 331 or the second link 332. Accordingly, information indicating an operation in a specific mode may include information on the third link having an STR relationship with the first link 331 or the second link 332. According to an embodiment, the information on the third link may include channel information of the third link, identification information of the third link, address information of a MAC corresponding to the third link, and a transmission period of a beacon transmitted through the third link.

The processor 530 may transmit information of the second link 332 and information of the third link to the external electronic device 320 through the first link 331 while operating in an operation mode (e.g., non-STR mode or EMLSR mode) in which data reception is not possible through the second link 332 while transmitting data to the external electronic device 320 through the first link 331.

The processor 530 may transmit information indicating an operation in a specific mode to the external electronic device 320 through the first link 331 while transmitting a signal (e.g., ready-to-send (RTS) frame) requesting permission for data transmission through the first link 331. Alternatively, the processor 530 may transmit an RTS frame including information indicating an operation in a specific mode to the external electronic device 320 through the first link 331.

The external electronic device 320 may receive information indicating that the electronic device 310 operates in a specific mode and monitor the state of the second link 332. As described above, while the electronic device 310 transmits data through the first link 331, it may be impossible that the electronic device 310 receives data (or signal) through the second link 332, and it may be difficult that the electronic device 310 identifies the state of the second link 332. In the case that the electronic device 310 operates in a specific mode, the external electronic device 320 may monitor the state of the second link 332 instead of the electronic device 310.

The external electronic device 320 may monitor the state of the second link 332 and identify that the second link 332 is in an idle state. The idle state may refer to a state in which other external electronic devices including the electronic device 310 do not transmit and/or receive data through the second link 332. As the external electronic device 320 identifies that the second link 332 is in an idle state, the external electronic device 320 may transmit information indicating that data transmission is possible through the second link to the electronic device 310.

According to an embodiment, the external electronic device 320 may transmit information indicating that data transmission is possible through the second link to the electronic device 310 through the third link having an STR relationship with the second link 332 rather than the second link 332, considering that the electronic device 310 is unable to receive data (or signal) through the second link 332.

According to an embodiment, the external electronic device 320 may transmit information indicating that data transmission is possible to the electronic device 310 through the second link 332 and the third link having an STR relationship with the second link 332, considering that transmission of data (or signal) may be completed through the first link 331.

Information indicating that data transmission is possible through the second link 332 may be implemented in various ways. According to an embodiment, information indicating that data transmission is possible through the second link 332 may be included in a clear-to-send (CTS) frame. The processor 530 may receive, through the third link, a CTS frame including information indicating that data transmission is possible through the second link 332.

As the processor 530 receives information indicating that data transmission is possible through the second link 332, the processor 530 may transmit data to the external electronic device 320 through the second link 332. When the processor 530 receives information indicating that data transmission is possible through the second link 332 through the third link while transmitting data through the first link 331, the processor 530 may transmit data to the external electronic device 320 through the second link 332. When the processor 530 receives information indicating that data transmission is possible through the second link 332 through the third link while transmitting data through the first link 331, the processor 530 may transmit data to the external electronic device 320 through the first link 331 and the second link 332.

As described above, when the processor 530 receives information indicating that data transmission is possible through the second link 332 even while transmitting data through the first link 331, the processor 530 may transmit data to the external electronic device 320 through the second link 332. Accordingly, the electronic device 310 may simultaneously perform data transmission through the first link 331 and data transmission through the second link 332 while operating in the non-STR mode or EMLSR mode in which data reception is impossible through the second link 332 (or while operating in the non-STR mode or EMLSR mode in which the state of the second link 332 may not be monitored) while transmitting data through the first link 331, thereby implementing a fast transmission speed.

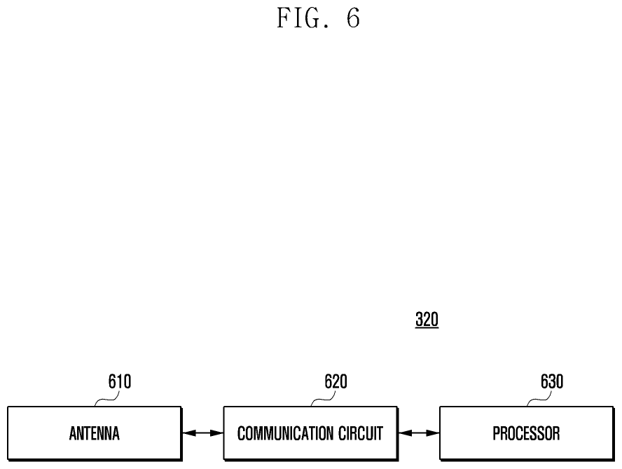

FIG. 6 is a block diagram illustrating an external electronic device 320 according to an embodiment.

According to an embodiment, the external electronic device 320 may include an antenna 610 (e.g., the third antenna 323 and the fourth antenna 324 of FIG. 3), a communication circuit 620 (e.g., the third communication circuit 321 and the fourth communication circuit 322 of FIG. 3), and/or a processor 630 (e.g., the processor 120 of FIG. 1).

According to an embodiment, the antenna 610 may receive a signal transmitted by the electronic device (e.g., the electronic device 310 of FIG. 5) or transmit a signal to the electronic device 310. In the case that the external electronic device 320 supports an MLO, the external electronic device 320 may transmit or receive a signal of a frequency band corresponding to the first link (e.g., the first link 331 of FIG. 3) and transmit or receive a signal of a frequency band corresponding to the second link (e.g., the second link 332 of FIG. 3). The antenna 610 may be implemented into a plurality of antennas.

The communication circuit 620 may transmit data to the electronic device 310 through the first link 331, or receive data transmitted by the electronic device 310 through the first link 331. The communication circuit 620 may transmit data to the electronic device 310 through the second link 332, or receive data transmitted by the electronic device 310 through the second link 332. The communication circuit 620 may output or receive a signal of a frequency band corresponding to the first link 331 through the antenna 610, and output or receive a signal of a frequency band corresponding to the second link 332 through the antenna 610.

The processor 630 may be operatively connected, directly or indirectly, to the communication circuit 620 to control the operation of the communication circuit 620.

The processor 630 may determine whether to activate a mode capable of transmitting information indicating that data transmission is possible through the second link 332 to the electronic device 310 through the third link, which is a link having an STR relationship with the second link 332. The third link, which is a link having an STR relationship with the second link 332, may refer to a link capable of receiving data through the third link while transmitting data through the second link 332 or a link capable of receiving data through the second link 332 while transmitting data through the third link.

According to an embodiment, in the case that the state of the electronic device 310 satisfies a designated condition, the processor 630 may determine to activate a mode capable of transmitting information indicating that data transmission is possible through the second link 332 to the electronic device 310 through the third link, which is a link having an STR relationship with the second link 332.

According to an embodiment, the designated condition may include a condition in which the electronic device 310 performs a service requiring low latency. As the processor 630 identifies that the packet transmitted by the electronic device 310 includes a packet related to a service requiring low latency (e.g., a packet having an access category (AC) of AC_VO), the processor 630 may determine that a designated condition is satisfied, and activate a mode capable of transmitting information indicating that data transmission is possible through the second link 332 to the electronic device 310 through the third link, which is a link having an STR relationship with the second link 332.

According to an embodiment, the designated condition may be a condition related to the size of data to be transmitted by the electronic device 310. The designated condition may be a condition in which data to be transmitted by the electronic device 310 is greater than or equal to the designated size. In the case that data to be transmitted by the electronic device 310 is greater than or equal to the designated size, the transmission speed may be improved by performing transmission through a plurality of links. The processor 630 may receive a buffer status report of the electronic device 310 from the electronic device 310 and determine whether the designated condition is satisfied based on the size of data temporarily stored in the buffer included in the buffer status report.

According to an embodiment, the designated condition may include a condition in which the electronic device 310 supports a mode capable of receiving information indicating that data transmission is possible through the second link 332 through a third link, which is a link having an STR relationship with the second link 332. As the processor 630 identifies that the electronic device 310 supports a mode capable of receiving information indicating that data transmission is possible through the second link 332 through the third link, which is a link having an STR relationship with the second link 332, the processor 630 may determine to activate a mode capable of transmitting information indicating that data transmission is possible through the second link 332 through the third link, which is a link having an STR relationship with the second link 332. According to an embodiment, the processor 630 may receive, from the electronic device 310, information indicating support of a mode capable of receiving information indicating that data transmission is possible through the second link 332 through the third link, which is a link having an STR relationship with the second link 332. Information indicating support of a mode capable of transmitting information indicating that data transmission is possible through the second link 332 through the third link, which is a link having an STR relationship with the second link 332 may be included in a vendor specific action frame defined in IEEE 802.11. The vendor specific action frame may include a field (vendor specific content) including information added by a vendor, and information indicating support of a mode capable of transmitting information indicating that data transmission is possible through the second link 332 through the third link, which is a link having an STR relationship with the second link 332, may be included in a field (vendor specific content) including information added by the vendor.

As the processor 630 activates a mode capable of transmitting information indicating that data transmission is possible through the second link 332 through the third link, which is a link having an STR relationship with the second link 332, the processor 630 may activate the third link or maintain an activated state of the third link in the case that the third link is already activated.

As the processor 630 activates a mode capable of transmitting information indicating that data transmission is possible through the second link 332 through the third link, which is a link having an STR relationship with the second link 332, the processor 630 may receive, from the electronic device 320, information indicating activation of a mode capable of transmitting information indicating that data transmission is possible through the second link 332 through the third link, which is a link having an STR relationship with the second link 332. The processor 630 may receive, from the electronic device 310 through the first link 331, information indicating activation of a mode (hereinafter, defined as a specific mode) capable of transmitting information indicating that data transmission is possible through the second link 332 through the third link, which is a link having an STR relationship with the second link 332.

Information indicating an operation in a specific mode may include information indicating links having a non-STR relationship. Links having a non-STR relationship may refer to links that cannot receive data through another link while transmitting data through one link. According to an embodiment, in the case that the electronic device 310 cannot receive data through the second link 332 while transmitting data through the first link 331, information indicating an operation in a specific mode may include information on the first link 331 and information on the second link 332. According to an embodiment, the information on the first link 331 may include channel information of the first link 331, identification information of the first link 331, address information of a medium access control (MAC) corresponding to the first link 331, and a transmission period of a beacon transmitted through the first link 331. According to an embodiment, the information on the second link 332 may include channel information of the second link 332, identification information of the second link 332, address information of a MAC corresponding to the second link 332, and a transmission period of a beacon transmitted through the second link 332.

Information indicating an operation in a specific mode may include information indicating links having an STR relationship. Links having an STR relationship may refer to links capable of receiving data through another link while transmitting data through one link. According to an embodiment, while the electronic device 310 transmits data through the first link 331 or the second link 332, in the case that data reception is possible through a third link, information indicating an operation in a specific mode may include information on the third link. According to an embodiment, the information on the third link may include channel information of the third link, identification information of the third link, address information of a MAC corresponding to the third link, and a transmission period of a beacon transmitted through the third link.

The processor 630 may receive information of the second link 332 and information of the third link from the electronic device 310 through the first link 331 while the electronic device 310 is operating in an operation mode (e.g., non-STR mode or EMLSR mode) in which data reception is not possible through the second link 332 while transmitting data to the external electronic device 320 through the first link 331.

The electronic device 310 may transmit information indicating an operation in a specific mode to the external electronic device 320 through the first link 331 while transmitting a signal (e.g., ready-to-send (RTS) frame) requesting permission for data transmission through the first link 331. Alternatively, the electronic device 310 may transmit an RTS frame including information indicating an operation in a specific mode to the external electronic device 320 through the first link 331.

The processor 630 may receive information indicating that the electronic device 310 operates in a specific mode and monitor the state of the second link 332. As described above, while the electronic device 310 transmits data through the first link 331, it may be impossible that the electronic device 310 receives data (or signal) through the second link 332, and it may be difficult that the electronic device 310 identifies the state of the second link 332. In the case that the electronic device 310 operates in a specific mode, the processor 630 may monitor the state of the second link 332 instead of the electronic device 310.

The processor 630 may monitor the state of the second link 332 and identify that the second link 332 is in an idle state. The idle state may refer to a state in which other external electronic devices including the electronic device 310 do not transmit and/or receive data through the second link 332. As the processor 630 identifies that the second link 332 is in an idle state, the processor 630 may transmit information indicating that data transmission is possible through the second link to the electronic device 310.

According to an embodiment, the processor 630 may transmit information indicating that data transmission is possible through the second link to the electronic device 310 through the third link having an STR relationship with the second link 332 rather than the second link 332 considering that the electronic device 310 is unable to receive data (or signal) through the second link 332.

According to an embodiment, the processor 630 may transmit information indicating that data transmission is possible to the electronic device 310 through the second link 332 and a third link having an STR relationship with the second link 332, considering that transmission of data (or signal) may be completed through the first link 331.

Information indicating that data transmission is possible through the second link 332 may be implemented in various ways. According to an embodiment, information indicating that data transmission is possible through the second link 332 may be included in a clear-to-send (CTS) frame. The processor 630 may transmit a CTS frame including information indicating that data transmission is possible through the second link 332 to the electronic device 310 through the third link.

As the electronic device 310 receives information indicating that data transmission is possible through the second link 332, the electronic device 310 may transmit data to the external electronic device 320 through the second link 332. When the electronic device 310 receives information indicating that data transmission is possible through the second link 332 through the third link while transmitting data through the first link 331, the electronic device 310 may transmit data to the external electronic device 320 through the second link 332. When the electronic device 310 receives information indicating that data transmission is possible through the second link 332 through the third link while transmitting data through the first link 331, the electronic device 310 may transmit data to the external electronic device 320 through the first link 331 and the second link 332.

The processor 630 may receive data transmitted by the electronic device 310 through the first link 331 and the second link 332.

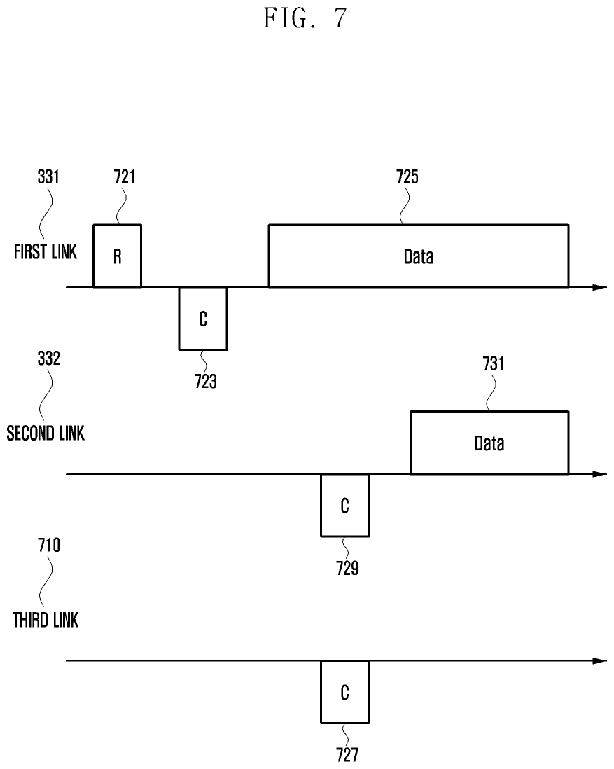

FIG. 7 is a diagram illustrating an embodiment in which an electronic device receives information indicating that transmission of data is possible through a second link through a third link according to an embodiment.

With reference to FIG. 7, the electronic device (e.g., the electronic device 310 of FIG. 5) may perform a series of operations for transmitting data through a first link 331.

In FIG. 7, for convenience of description, it is assumed that the first link 331 and a second link 332 have a non-STR relationship and that the first link 331 and a third link 710 have a STR relationship and that the second link 332 and the third link 710 have a STR relationship.

The electronic device 310 may control the communication circuit 520 to transmit data to the external electronic device 320 using a non-STR mode or an EMLSR mode among modes supported by the multi-link operation.

In the case that the state of the electronic device 310 satisfies a designated condition while the electronic device 310 operates in a non-STR mode or an EMLSR mode, the electronic device 310 may determine to activate a mode capable of receiving information indicating that data transmission is possible through the second link 332 through the third link, which is a link having an STR relationship with the second link 332.

The electronic device 310 may activate a timer allocated to the first link 331 and identify whether a time configured in the timer has expired. As the time configured in the timer has expired, the electronic device 310 may transmit a signal (e.g., RTS frame) 721 requesting permission for data transmission through the first link 331 to the external electronic device 320 through the first link in order to transmit data through the first link 331.

As the electronic device 310 activates a mode capable of receiving information indicating that data transmission is possible through the second link 332 through the third link, which is a link having an STR relationship with the second link 332, the electronic device 310 may transmit information indicating activation of a mode capable of transmitting information indicating that data transmission is possible through the second link 332 to the external electronic device 320 through the third link, which is a link having an STR relationship with the second link 332.

The electronic device 310 may transmit information indicating activation of a mode (hereinafter, defined as a specific mode) capable of transmitting information indicating that data transmission is possible through the second link 332 through the third link, which is a link having an STR relationship with the second link 332, to the external electronic device 320 through the first link 331.

Information indicating an operation in a specific mode may include information indicating links having a non-STR relationship. Links having a non-STR relationship may refer to links that cannot receive data through another link while transmitting data through one link. According to an embodiment, in the case that the electronic device 310 cannot receive data through the second link 332 while transmitting data through the first link 331, information indicating an operation in a specific mode may include information on the first link 331 and information on the second link 332.

Information indicating an operation in a specific mode may include information indicating links having an STR relationship. Links having an STR relationship may refer to links capable of receiving data through another link while transmitting data through one link. According to an embodiment, in the case that the electronic device 310 may receive data through the third link while transmitting data through the first link 331 or the second link 332, information indicating an operation in a specific mode may include information on the third link.

The electronic device 310 may transmit information indicating an operation in a specific mode to the external electronic device 320 through the first link 331 while transmitting a signal 721 requesting permission for data transmission through the first link 331. Alternatively, the processor 530 may transmit an RTS frame including information indicating an operation in a specific mode to the external electronic device 320 through the first link 331.

The external electronic device 320 may receive a signal 721 requesting permission for data transmission from the electronic device 310 through the first link 331, and transmit information (e.g., clear-to-send (CTS) frame) 723 indicating that data transmission is possible through the first link 331 to the electronic device 310 through the first link 331.

As the electronic device 310 receives information 723 indicating that data transmission is possible through the first link 331, the electronic device 310 may transmit data 725 to the external electronic device 320 through the first link 331.

As the external electronic device 320 receives, from the electronic device 310, information indicating that the electronic device 310 operates in a specific mode, the external electronic device 320 may monitor the state of the second link 332. While the electronic device 310 transmits data through the first link 331, it may be impossible that the electronic device 310 receives data (or signal) through the second link 332, and it may be difficult that the electronic device 310 identifies the state of the second link 332. In the case that the electronic device 310 operates in a specific mode, the external electronic device 320 may monitor the state of the second link 332 instead of the electronic device 310.

The external electronic device 320 may monitor a state of the second link 332 and identify that the second link 332 is in an idle state. The idle state may refer to a state in which other external electronic devices including the electronic device 310 do not transmit and/or receive data through the second link 332. As the external electronic device 320 identifies that the second link 332 is in an idle state, the external electronic device 320 may transmit information indicating that data transmission is possible through the second link to the electronic device 310.

According to an embodiment, the external electronic device 320 may transmit information 727 indicating that data transmission is possible through the second link to the electronic device 310 through the third link 710 having an STR relationship with the second link 332 rather than the second link 332, considering that the electronic device 310 is unable to receive data (or signal) through the second link 332.

According to an embodiment, the external electronic device 320 may transmit information 727 and 729 indicating that data transmission is possible to the electronic device 310 through the second link 332 and the third link 710 having an STR relationship with the second link 332, considering that transmission of data (or signal) through the first link 331 may be completed.

Information indicating that data transmission is possible through the second link 332 may be implemented in various ways. According to an embodiment, information indicating that data transmission is possible through the second link 332 may be included in a clear-to-send (CTS) frame. The electronic device 310 may receive a CTS frame including information 727 indicating that data transmission is possible through the second link 332 through the third link 710.

The electronic device 310 may receive a CTS frame including information 727 indicating that data transmission is possible through the second link 332 through the third link 710 and transmit data 731 to the external electronic device 320 through the second link 332.

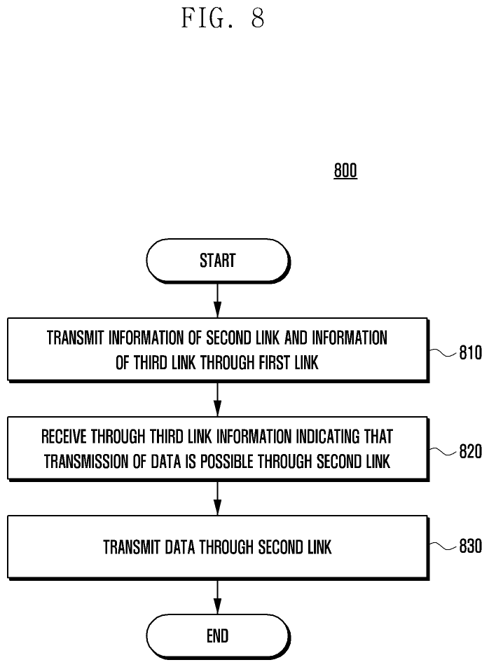

FIG. 8 is a flowchart 800 illustrating a method of operating an electronic device according to an embodiment.

In operation 810, the electronic device (e.g., the electronic device 310 of FIG. 5) may transmit information of the second link (e.g., the second link 332 of FIG. 7) and information of the third link (e.g., the third link 710 of FIG. 7) to the external electronic device 320 through the first link (e.g., the first link 331 of FIG. 7).

The electronic device 310 may control the communication circuit 520 to transmit data to the external electronic device 320 using a non-STR mode or an EMLSR mode among modes supported by a multi-link operation.

In the case that the state of the electronic device 310 satisfies a designated condition while the electronic device 310 operates in a non-STR mode or an EMLSR mode, the electronic device 310 may determine to activate a mode capable of receiving information indicating that data transmission is possible through the second link 332 through the third link 710, which is a link having an STR relationship with the second link 332.

According to an embodiment, the designated condition may include a condition for performing a service requiring low latency. The electronic device 310 may determine to activate a mode capable of receiving information indicating that data transmission is possible through the second link 332 through the third link 710, which is a link having an STR relationship with the second link 332 upon detecting that an application performing a service requiring low latency is executed.

According to an embodiment, the designated condition may include a condition in which the external electronic device 320 supports a mode capable of transmitting information indicating that data transmission is possible through the second link 332 through the third link 710, which is a link having an STR relationship with the second link 332. As the electronic device 310 identifies that the external electronic device 320 supports a mode capable of transmitting information indicating that data transmission is possible through the second link 332 through the third link 710, which is a link having an STR relationship with the second link 332, the electronic device 310 may determine to activate a mode capable of receiving information indicating that data transmission is possible through the second link 332 through the third link 710, which is a link having an STR relationship with the second link 332. According to an embodiment, the electronic device 310 may receive, from the external electronic device 320, information indicating that the electronic device 310 supports a mode capable of transmitting information indicating that data transmission is possible through the second link 332 through the third link 710, which is a link having an STR relationship with the second link 332. Information indicating support of a mode capable of transmitting information indicating that data transmission is possible through the second link 332 through the third link 710, which is a link having an STR relationship with the second link 332 may be included in a vendor specific action frame defined in IEEE 802.11. The vendor specific action frame may include a field (vendor specific content) including information added by a vendor, and information indicating support of a mode capable of transmitting information indicating that data transmission is possible through the second link 332 through the third link 710, which is a link having an STR relationship with the second link 332 may be included in a field (vendor specific content) including information added by the vendor.

As the electronic device 310 activates a mode capable of receiving information indicating that data transmission is possible through the second link 332 through the third link 710, which is a link having an STR relationship with the second link 332, the electronic device 310 may activate the third link 710 or maintain an activated state of the third link 710 in the case that the third link 710 is already activated.

As the electronic device 310 activates a mode capable of receiving information indicating that data transmission is possible through the second link 332 through the third link 710, which is a link having an STR relationship with the second link 332, the electronic device 310 may transmit, to the external electronic device 320, information indicating activation of a mode capable of receiving information indicating that data transmission is possible through the second link 332 through the third link 710, which is a link having an STR relationship with the second link 332. The electronic device 310 may transmit information indicating activation of a mode (hereinafter, defined as a specific mode) capable of receiving information indicating that data transmission is possible through the second link 332 through the third link 710, which is a link having an STR relationship with the second link 332 to the external electronic device 320 through the first link 331.

Information indicating an operation in a specific mode may include information indicating links having a non-STR relationship. Links having a non-STR relationship may refer to links that cannot receive data through another link while transmitting data through one link. According to an embodiment, in the case that the electronic device 310 cannot receive data through the second link 332 while transmitting data through the first link 331, information indicating an operation in a specific mode may include information on the first link 331 and information on the second link 332. According to an embodiment, the information on the first link 331 may include channel information of the first link 331, identification information of the first link 331, address information of a medium access control (MAC) corresponding to the first link 331, and a transmission period of a beacon transmitted through the first link 331. According to an embodiment, the information on the second link 332 may include channel information of the second link 332, identification information of the second link 332, address information of a MAC corresponding to the second link 332, and a transmission period of a beacon transmitted through the second link 332.

Information indicating an operation in a specific mode may include information indicating links having an STR relationship. Links having an STR relationship may refer to links that may receive data through another link while transmitting data through one link. According to an embodiment, in the case that the electronic device 310 may receive data through the third link 710 while transmitting data through the first link 331 or the second link 332, the third link 710 may have an STR relationship with the first link 331 or the second link 332. Accordingly, information indicating an operation in a specific mode may include information on the third link 710 having an STR relationship with the first link 331 or the second link 332. According to an embodiment, the information on the third link 710 may include channel information of the third link 710, identification information of the third link 710, address information of a MAC corresponding to the third link 710, and a transmission period of a beacon transmitted through the third link 710.

The electronic device 310 may transmit information of the second link 332 and information of the third link 710 to the external electronic device 320 through the first link 331 while operating in an operation mode (e.g., non-STR mode or EMLSR mode) in which data reception is not possible through the second link 332 while transmitting data to the external electronic device 320 through the first link 331.

The electronic device 310 may transmit information indicating an operation in a specific mode to the external electronic device 320 through the first link 331 while transmitting a signal (e.g., ready-to-send (RTS) frame) requesting permission for data transmission through the first link 331. Alternatively, the electronic device 310 may transmit an RTS frame including information indicating an operation in a specific mode to the external electronic device 320 through the first link 331.

In operation 820, the electronic device 310 may receive, through the third link 710, information indicating that transmission of data is possible through the second link 332.

The external electronic device 320 may receive information indicating that the electronic device 310 operates in a specific mode and monitor a state of the second link 332. As described above, while the electronic device 310 transmits data through the first link 331, it may be impossible that the electronic device 310 receives data (or signal) through the second link 332, and it may be difficult that the electronic device 310 identifies a state of the second link 332. In the case that the electronic device 310 operates in a specific mode, the external electronic device 320 may monitor a state of the second link 332 instead of the electronic device 310.

The external electronic device 320 may monitor a state of the second link 332 and identify that the second link 332 is in an idle state. The idle state may refer to a state in which other external electronic devices including the electronic device 310 do not transmit and/or receive data through the second link 332. As the external electronic device 320 identifies that the second link 332 is in an idle state, the external electronic device 320 may transmit information indicating that data transmission is possible through the second link to the electronic device 310.

According to an embodiment, the external electronic device 320 may transmit, to the electronic device 310, information indicating that data transmission is possible through the second link through the third link 710 having an STR relationship with the second link 332 rather than the second link 332, considering that the electronic device 310 is unable to receive data (or signal) through the second link 332.

According to an embodiment, the external electronic device 320 may transmit, to the electronic device 310, information indicating that data transmission is possible through the second link 332 and the third link 710 having an STR relationship with the second link 332, considering that transmission of data (or signal) may be completed through the first link 331.

Information indicating that data transmission is possible through the second link 332 may be implemented in various ways. According to an embodiment, information indicating that data transmission is possible through the second link 332 may be included in a clear-to-send (CTS) frame. The electronic device 310 may receive a CTS frame including information indicating that data transmission is possible through the second link 332 through the third link 710.

In operation 830, the electronic device 310 may transmit data to the external electronic device 320 through the second link 332.

As the electronic device 310 receives information indicating that data transmission is possible through the second link 332, the electronic device 310 may transmit data to the external electronic device 320 through the second link 332. When the electronic device 310 receives information indicating that data transmission is possible through the second link 332 through the third link 710 while transmitting data through the first link 331, the electronic device 310 may transmit data to the external electronic device 320 through the second link 332. When the electronic device 310 receives information indicating that data transmission is possible through the second link 332 through the third link 710 while transmitting data through the first link 331, the electronic device 310 may transmit data to the external electronic device 320 through the first link 331 and the second link 332.

As described above, even if the electronic device 310 is transmitting data through the first link 331, if the electronic device 310 receives information indicating that data transmission is possible through the second link 332, the electronic device 310 may transmit data to the external electronic device 320 through the second link 332. Accordingly, while the electronic device 310 is operating in a non-STR mode or EMLSR mode in which data reception is impossible through the second link 332 (or the non-STR mode or EMLSR mode in which the state of the second link 332 may not be monitored) while transmitting data through the first link 331, the electronic device 310 may simultaneously perform data transmission through the first link 331 and data transmission through the second link 332, thereby implementing a fast transmission speed.

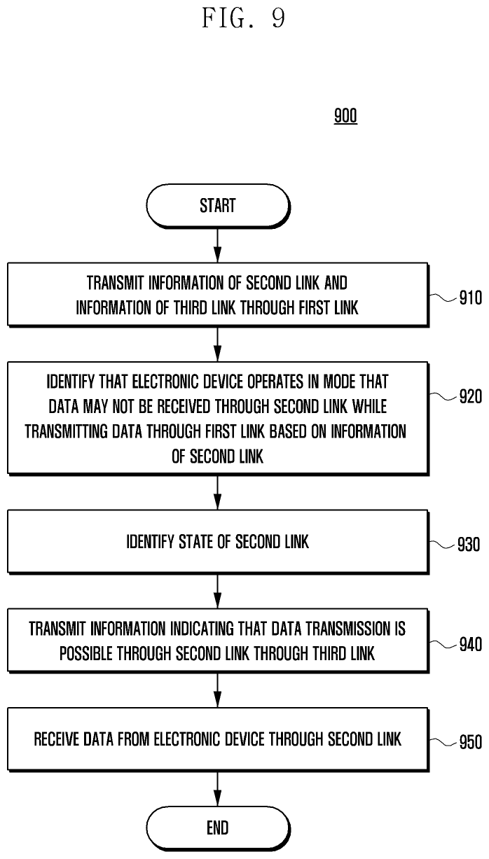

FIG. 9 is a flowchart 900 illustrating a method of operating an electronic device according to an embodiment.

With reference to FIG. 9, in operation 910, an external electronic device (e.g., the external electronic device 320 of FIG. 6) may receive information of a second link (e.g., the second link 332 of FIG. 7) and information of a third link (e.g., the third link 710 of FIG. 7) through a first link (e.g., the first link 331 of FIG. 7).

According to an embodiment, the electronic device 310 and the external electronic device 320 may perform a series of operations of establishing a plurality of links in order to transmit and/or receive data through the plurality of links (e.g., the first link 331, the second link 332, and the third link). In a process of establishing a plurality of links, the electronic device 310 may transmit information of the first link 331, information of the second link 332, and/or information of the third link to the external electronic device 320. In a process of receiving information of the second link 332 and/or information of the third link, the external electronic device 320 may receive, from the electronic device 310, information indicating activation of a mode capable of receiving information indicating that data transmission is possible through the second link 332 through the third link, which is a link having an STR relationship with the second link 332.

As the electronic device 310 activates a mode capable of transmitting information indicating that data transmission is possible through the second link 332 through the third link, which is a link having an STR relationship with the second link 332, the external electronic device 320 may receive, from the electronic device 310, information indicating activation of a mode capable of receiving information indicating that data transmission is possible through the second link 332 through the third link, which is a link having an STR relationship with the second link 332.

The external electronic device 320 may receive, from the electronic device 310 through the first link 331, information indicating activation of a mode (hereinafter, defined as a specific mode) capable of receiving information indicating that data transmission is possible through the second link 332 through the third link, which is a link having an STR relationship with the second link 332.

Information indicating an operation in a specific mode may include information indicating links having a non-STR relationship. Links having a non-STR relationship may refer to links that cannot receive data through another link while transmitting data through one link. According to an embodiment, in the case that the electronic device 310 cannot receive data through the second link 332 while transmitting data through the first link 331, information indicating an operation in a specific mode may include information on the first link 331 and information on the second link 332. According to an embodiment, the information on the first link 331 may include channel information of the first link 331, identification information of the first link 331, address information of a medium access control (MAC) corresponding to the first link 331, and a transmission period of a beacon transmitted through the first link 331. According to an embodiment, the information on the second link 332 may include channel information of the second link 332, identification information of the second link 332, address information of a MAC corresponding to the second link 332, and a transmission period of a beacon transmitted through the second link 332.

Information indicating an operation in a specific mode may include information indicating links having an STR relationship. Links having an STR relationship may refer to links capable of receiving data through another link while transmitting data through one link. According to an embodiment, in the case that the electronic device 310 may receive data through the third link while transmitting data through the first link 331 or the second link 332, the third link may have an STR relationship with the first link 331 or the second link 332. Accordingly, information indicating an operation in a specific mode may include information on the third link having an STR relationship with the first link 331 or the second link. According to an embodiment, the information on the third link may include channel information of the third link, identification information of the third link, address information of a MAC corresponding to the third link, and a transmission period of a beacon transmitted through the third link.

The external electronic device 320 may receive information of the second link 332 and information of the third link from the electronic device 310 through the first link 331 while the electronic device 310 is operating in an operation mode (e.g., non-STR mode or EMLSR mode) in which data reception is not possible through the second link 332 while transmitting data to the external electronic device 320 through the first link 331.

The electronic device 310 may transmit information indicating an operation in a specific mode to the external electronic device 320 through the first link 331 while transmitting a signal (e.g., ready-to-send (RTS) frame) requesting permission for data transmission through the first link 331. Alternatively, the electronic device 310 may transmit an RTS frame including information indicating an operation in a specific mode to the external electronic device 320 through the first link 331.

In operation 920, the external electronic device 320 may identify that the electronic device 310 operates in a mode that data may not be received through the second link 332 while transmitting data through the first link 331 based on information of the second link 332.

In the case that the external electronic device 320 identifies that information of a link having a non-STR relationship with the second link 332 is included in information of the second link 332, the external electronic device 320 may identify that the electronic device 310 operates in a mode that data may not be received through the second link 332 while transmitting data through the first link 331.

In operation 930, the external electronic device 320 may identify a state of the second link 332.

The external electronic device 320 may receive information indicating that the electronic device 310 operates in a specific mode and monitor the state of the second link 332. As described above, while the electronic device 310 transmits data through the first link 331, it may be impossible that the electronic device 310 receives data (or signal) through the second link 332, and it may be difficult that the electronic device 310 identifies the state of the second link 332. In the case that the electronic device 310 operates in a specific mode, the external electronic device 320 may monitor the state of the second link 332 instead of the electronic device 310.

In operation 940, the external electronic device 320 may transmit information indicating that data transmission is possible through the second link 332 to the electronic device 310 through the third link 710.

The external electronic device 320 may monitor the state of the second link 332 and identify that the second link 332 is in an idle state. The idle state may refer to a state in which other external electronic devices including the electronic device 310 do not transmit and/or receive data through the second link 332. As the external electronic device 320 identifies that the second link 332 is in an idle state, the external electronic device 320 may transmit information indicating that data transmission is possible through the second link 332 to the electronic device 310.

According to an embodiment, the external electronic device 320 may transmit information indicating that data transmission is possible to the electronic device 310 through the second link 332 and the third link 710 having an STR relationship with the second link 332 considering that transmission of data (or signal) may be completed through the first link 331.

Information indicating that data transmission is possible through the second link 332 may be implemented in various ways. According to an embodiment, information indicating that data transmission is possible through the second link 332 may be included in a clear-to-send (CTS) frame. The external electronic device 320 may transmit a CTS frame including information indicating that data transmission is possible through the second link 332 to the electronic device 310 through the third link 710.

The electronic device 310 may transmit data to the external electronic device 320 through the second link 332 upon receiving information indicating that data transmission is possible through the second link 332. When the electronic device 310 receives information indicating that data transmission is possible through the second link 332 through the third link 710 while transmitting data through the first link 331, the electronic device 310 may transmit data to the external electronic device 320 through the second link 332. When the electronic device 310 receives information indicating that data transmission is possible through the second link 332 through the third link 710 while transmitting data through the first link 331, the electronic device 310 may transmit data to the external electronic device 320 through the first link 331 and the second link 332.

In operation 950, the external electronic device 320 may receive data from the electronic device 310 through the second link 332.

An electronic device (e.g., the electronic device 310 of FIG. 5) according to an embodiment may include at least one antenna (e.g., the antenna 510 of FIG. 5). The electronic device 310 may include a communication circuit (e.g., the communication circuit 520 of FIG. 5) electrically connected, directly or indirectly, to the antenna 510 and configured to transmit and receive data through at least one link among a plurality of links including a first link (e.g., the first link 331 of FIG. 4B), a second link (e.g., the second link 332 of FIG. 4B), and a third link (e.g., the third link 710 of FIG. 7) generated between an external electronic device (e.g., the external electronic device 320 of FIG. 6) and the electronic device 310. The electronic device 310 may include a processor (e.g., the processor 530 of FIG. 5) operatively connected, directly or indirectly, to the communication circuit 520. When the processor 530 operates in an operation mode in which data may not be received through the second link 332 while transmitting data to the external electronic device 320 through the first link 331, the processor 530 may transmit information of the second link 332 and the third link 710 to the external electronic device 320 through the first link 331. While the processor 530 transmits data to the external electronic device 320 through the first link 331, the processor 530 may receive information indicating that data transmission is possible through the second link 332 from the external electronic device 320 through the third link 710. The processor 530 may be configured to transmit data to the external electronic device 320 through the second link 332.

In an electronic device 310 according to an embodiment, the processor 530 may be configured to transmit a signal requesting permission for data transmission through the first link 331 together with information on the second link 332 and the third link 710.

In an electronic device 310 according to an embodiment, the processor 530 may receive, from the external electronic device 320, information indicating that the external electronic device 320 supports a mode for transmitting information indicating that data transmission is possible through the second link 332. In the case that the processor 530 receives information indicating that the external electronic device 320 supports a mode for transmitting information indicating that data transmission is possible through the second link 332, the processor 530 may be configured to activate the third link 710 or maintain an activated state of the third link 710.

In an electronic device 310 according to an embodiment, information indicating that the external electronic device 320 supports a mode for transmitting information indicating that data transmission is possible through the second link 332 may be included in a vendor specific action frame.

In an electronic device 310 according to an embodiment, in the case that the electronic device 310 satisfies a designated condition, the processor 530 may be configured to transmit, to the external electronic device 320, a signal requesting activation of a mode for transmitting information indicating that data transmission is possible through the second link 332 through the third link 710.

In an electronic device 310 according to an embodiment, the designated condition may include a condition in which a service being performed by the electronic device 310 is a service requiring low latency.

In an electronic device 310 according to an embodiment, information indicating that data transmission from the external electronic device 320 is possible through the second link 332 may be included in a clear to send (CTS) frame.

An electronic device (e.g., the external electronic device 320 of FIG. 6) according to an embodiment may include at least one antenna (e.g., the antenna 610 of FIG. 6). The electronic device 320 may include a communication circuit (e.g., the communication circuit 620 of FIG. 6) electrically connected, directly or indirectly, to the antenna 610 and configured to transmit and receive data through at least one link among a plurality of links including a first link (e.g., the first link 331 of FIG. 4B), a second link (e.g., the second link 332 of FIG. 4B), and a third link (e.g., the third link 710 of FIG. 7) generated between an external electronic device (e.g., the electronic device 310 of FIG. 5) and the electronic device 320. The electronic device 320 may include a processor (e.g., the processor 630 of FIG. 6) operatively connected to the communication circuit 620. The processor 630 may receive information of the second link 332 and the third link 710 through the first link 331. The processor 630 may identify that the external electronic device 310 operates in an operation mode in which data may not be received through the second link 332 while transmitting data to the electronic device 320 through the first link 331 based on information of the second link 332. The processor 630 may identify a state of the second link 332 while receiving data from the external electronic device 310 through the first link 331. When the processor 630 identifies that the state of the second link 332 is an idle state, the processor 630 may transmit information indicating that data transmission is possible through the second link 332 to the external electronic device 320 through the third link 710. The processor 630 may be configured to receive data from the external electronic device 310 through the second link 332.

In an electronic device 320 according to an embodiment, information of the second link 332 and the third link 710 may be received together with a signal requesting permission for data transmission through the first link 331.

In an electronic device 320 according to an embodiment, the processor 630 may receive information indicating a buffer state of the external electronic device 310 from the external electronic device 310. In the case that the buffer state satisfies a designated condition, the processor 630 may activate a mode for transmitting information indicating that data transmission is possible through the second link 332 through the first link 331 or the third link 710.

In an electronic device 320 according to an embodiment, the designated condition may include a condition in which a size of data temporarily stored in the buffer is greater than or equal to a designated size.

In an electronic device 320 according to an embodiment, the processor 630 may be configured to transmit a clear to send (CTS) frame including information indicating that data transmission is possible through the second link 332 to the external electronic device 310.

In an electronic device 320 according to an embodiment, the processor 630 may be configured to transmit, to the external electronic device 310 through the first link 331, information indicating support of a mode for transmitting information indicating that data transmission is possible through the second link 332 through the third link 710.

In an electronic device 320 according to an embodiment, information indicating support of a mode for transmitting information indicating that data transmission is possible through the second link 332 through the third link 710 may be included in a vendor specific action frame.

A method of operating an electronic device 310 according to an embodiment may include transmitting information of the second link 332 and the third link 710 to the external electronic device 320 through the first link 331 when operating in an operating mode in which data may not be received through the second link 332 while transmitting data to the external electronic device 320 through the first link 331. The method of operating the electronic device 310 may include receiving information indicating that data transmission is possible through the second link 332 from the external electronic device 320 through the third link 710 while transmitting data to the external electronic device 320 through the first link 331. The method of operating the electronic device 310 may include transmitting data to the external electronic device 320 through the second link 332.

A method of operating an electronic device 310 according to an embodiment may further include transmitting a signal requesting permission for data transmission through the first link 331 together with information on the second link 332 and the third link 710.

The method of operating the electronic device 310 according to an embodiment may further include receiving, from the external electronic device 320, information indicating that the external electronic device 320 supports a mode for transmitting information indicating that data transmission is possible through the second link 332. The method of operating the electronic device 310 may further include activating the third link 710 or maintaining an activated state of the third link 710 in the case that the external electronic device 320 receives information indicating support of a mode for transmitting information indicating that data transmission is possible through the second link 332.

In a method of operating an electronic device 310 according to an embodiment, information indicating that the external electronic device 320 supports a mode for transmitting information indicating that data transmission is possible through the second link 332 may be included in a vendor specific action frame.

The method of operating an electronic device 310 according to an embodiment may further include transmitting, to the external electronic device 320, a signal requesting activation of a mode for transmitting information indicating that data transmission is possible through the second link 332 through the third link 710 in the case that the electronic device 310 satisfies a designated condition.

In a method of operating an electronic device 310 according to an embodiment, the designated condition may include a condition in which a service being performed by the electronic device 310 is a service requiring low latency.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via at least a third element. Thus, for example, “connected” as used herein covers both direct and indirect connections.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC). Thus, each “module” herein may comprise circuitry.

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

The invention claimed is:

1. An electronic device, comprising:
at least one antenna;
a communication circuit electrically connected to the antenna and configured to transmit and receive data through at least one link among a plurality of links including a first link, a second link, and a third link to be generated between an external electronic device and the electronic device; and
at least one processor, comprising processing circuitry, operatively connected to the communication circuit,
wherein the at least one processor is individually and/or collectively configured to:
transmit information of the second link and the third link to the external electronic device through the first link when operating in an operation mode that data may not be received through the second link while transmitting data to the external electronic device through the first link,
receive information indicating that data transmission is possible through the second link from the external electronic device through the third link while transmitting data to the external electronic device through the first link, and
transmit data to the external electronic device through the second link.

2. The electronic device of claim 1, wherein the at least one processor is individually and/or collectively configured to transmit a signal requesting permission for data transmission through the first link together with information on the second link and the third link.

3. The electronic device of claim 1, wherein the at least one processor is individually and/or collectively configured to:
receive, from the external electronic device, information indicating that the external electronic device supports a mode for transmitting information indicating that data transmission is possible through the second link, and
activate the third link or maintain an activated state of the third link in the case that the external electronic device receives information indicating support of a mode for transmitting information indicating that data transmission is possible through the second link.

4. The electronic device of claim 3, wherein information indicating that the external electronic device supports a mode for transmitting information indicating that data transmission is possible through the second link is included in a vendor specific action frame.

5. The electronic device of claim 1, wherein the at least one processor is individually and/or collectively configured to transmit, to the external electronic device, a signal requesting activation of a mode for transmitting information indicating that data transmission is possible through the second link through the third link, in the case that the electronic device satisfies a designated condition.

6. The electronic device of claim 5, wherein the designated condition comprises a condition in which a service being performed by the electronic device is a service requiring low latency.

7. The electronic device of claim 1, wherein information indicating that data transmission is possible through the second link from the external electronic device is included in a clear to send (CTS) frame.

8. An electronic device, comprising:
at least one antenna;
a communication circuit electrically connected to the antenna and configured to transmit and receive data through at least one link among a plurality of links including a first link, a second link, and a third link to be generated between an external electronic device and the electronic device; and
at least one processor, comprising processing circuitry, operatively connected to the communication circuit,
wherein the at least one processor is, individually and/or collectively, configured to:
receive information of the second link and the third link through the first link,
identify that the external electronic device operates in an operation mode that data may not be received through the second link while transmitting data to the electronic device through the first link based on the information of the second link,
identify a state of the second link while receiving data from the external electronic device through the first link,
transmit information indicating that data transmission is possible through the second link to the external electronic device through the third link, if the processor identifies that the state of the second link is an idle state, and
receive data from the external electronic device through the second link.

9. The electronic device of claim 8, wherein information of the second link and the third link is received together with a signal requesting permission for data transmission through the first link.

10. The electronic device of claim 8, wherein the at least one processor is individually and/or collectively configured to:
receive information indicating a buffer state of the external electronic device from the external electronic device, and
activate a mode for transmitting information indicating that data transmission is possible through the second link through the first link or the third link in the case the buffer state satisfies a designated condition.

11. The electronic device of claim 8, wherein the designated condition comprises a condition in which a size of data temporarily stored in the buffer is greater than or equal to a designated size.

12. The electronic device of claim 8, wherein the at least one processor is individually and/or collectively configured to transmit, to the external electronic device, a clear to send (CTS) frame including information indicating that data transmission is possible through the second link.

13. The electronic device of claim 8, wherein the at least one processor is individually and/or collectively configured to transmit, to the external electronic device through the first link, information indicating support of a mode for transmitting information indicating that data transmission is possible through the second link through the third link.

14. The electronic device of claim 13, wherein information indicating support of a mode for transmitting information indicating that data transmission is possible through the second link through the third link is included in a vendor specific action frame.

15. A method of operating an electronic device, the method comprising:
transmitting information of the second link and the third link to the external electronic device through the first link when operating in an operation mode that data may not be received through the second link while transmitting data to the external electronic device through the first link;
receiving, from the external electronic device through the third link, information indicating that data transmission is possible through the second link while transmitting data to the external electronic device through the first link; and
transmitting data to the external electronic device through the second link.
